(19) United States
(12) Patent Application Publication
(10) Pub. No.: US 2025/0089039 A1
(43) Pub. Date: Mar. 13, 2025

(54) Long Range UWB and Wi-Fi Coexistence

(71) Applicant: Apple Inc., Cupertino, CA (US)

(72) Inventors: Camille Chen, Cupertino, CA (US); Shang-Te Yang, San Jose, CA (US); Helena D. O'Shea, San Diego, CA (US); Robert Golshan, San Francisco, CA (US); Lynn E. Greiner, Santa Clara, CA (US)

(21) Appl. No.: 18/825,890

(22) Filed: Sep. 5, 2024

Related U.S. Application Data
(60) Provisional application No. 63/581,237, filed on Sep. 7, 2023.

(51) Int. Cl. H04W 72/12; H04B 1/00; H04W 88/06

(52) U.S. Cl. CPC H04W 72/1215; H04B 1/0064; H04W 88/06

(57) ABSTRACT

Apparatuses, systems, and methods for radio coexistence of a first radio with a first radio access technology (RAT) and a second radio with a second RAT, including systems, methods, and mechanisms for a wireless device to send a request message, from the first radio to the second radio to request a communication. The request message includes a request for the first radio to communicate in one or more frequency ranges that the second radio is configured to communicate on; a lead time for the first radio to start the communication in the one or more frequency ranges; a duration of time for the communication by the first radio; and one or more antennas of the UE for the first radio to use for the communication over the duration.

### FIELD

The disclosed techniques relate to wireless communications, including apparatuses, systems, and methods for coexistence of wireless radio access technologies (RAT) with a narrowband (NB) radio to provide increased range.

### DESCRIPTION OF THE RELATED ART

Wireless communication technology has evolved from voice-only communications to also include the transmission of data, such as Internet and multimedia content, precise ranging and location, etc.

Mobile electronic devices may take the form of smart phones or tablets that a user typically carries. Wearable devices are a newer form of mobile electronic device, one example being smart watches. Additionally, low-cost low-complexity wireless devices intended for stationary or nomadic deployment are also proliferating as part of the developing “Internet of Things.” In other words, there is an increasingly wide range of desired device complexities, capabilities, traffic patterns, and other characteristics.

Additionally, there exist numerous different wireless communication technologies (also referred to as radio access technologies (RATs)) and standards. Some examples of wireless communication standards include Third Generation Partnership Project (3GPP) Fourth Generation (4G), 3GPP Long Term Evolution (LTE), 3GPP LTE Advanced (LTE-A), 3GPP Fifth Generation (5G), Institute of Electrical and Electronics Engineers (IEEE) 802.11 (Wi-Fi), IEEE 802.15, BLUETOOTH, etc.

In some implementations, multiple wireless communication technologies may share certain resources, such as an antenna, frequency, space, etc. For example, ultra-wideband (UWB) communications may utilize frequency ranges close to or overlapping with (or experiencing harmonics or other noise from) the frequency ranges used by Wi-Fi, which may lead to interference and congestion of the communication medium. Additionally, the proximity of frequency in the different RATs may lead to wireless device designs in which a UWB radio may share one or more antennas with a Wi-Fi radio.

Each new wireless communication technology or mode that is utilized or contending with resources that are used by another technology may further exacerbate these problems. Accordingly, improvements in the field are desired, e.g., to allow improved coexistence of various wireless communication standards operating with shared resources.

### SUMMARY

Embodiments relate to s communications, including to apparatuses, systems, and methods for radio coexistence between conflicting radios, including systems, methods, and mechanisms for a device to send a request message, from a first radio to a second radio, to request permission to communicate by the first radio in the device.

For example, in some embodiments, a request message can include a request for the first radio to communicate in one or more frequency ranges that the second radio is also configured to communicate on. The request message can also include a lead time for the first radio to start the communication in the one or more frequency ranges. The request message can also include a duration of time for the communication by the first radio. The request message can also include one or more antennas of the device for the first radio to use for the communication over the duration.

The device can receive a response message at the first radio from the second radio. The response message can comprise an availability or unavailability of the one or more antennas for the first radio over the duration. The response message can further include a communication permission or communication denial for the first radio to communicate in the one or more frequency ranges for the duration. The response message can also include a set of reduced resources that the first radio can communicate on. The first radio can communicate, based in part on the request message and the response message, to minimize the impact of the communication to other radios in the device and provide at least some concurrency between the radios.

The techniques described herein may be implemented in and/or used with a number of different types of devices, including but not limited to base stations, access points, cellular phones, tablet computers, wearable computing devices, portable media players, vehicles, and any of various other computing devices. The techniques described herein can also be implemented between multiple devices.

This summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of various embodiments is considered in conjunction with the following drawings, in which:

FIG. 1 illustrates an example of legacy ultra-wideband uses cases, according to some embodiments.

FIG. 2 illustrates an example of a wireless device, according to some embodiments.

FIG. 3 illustrates an example block diagram of a wireless device, according to some embodiments.

FIG. 4 illustrates an example block diagram of a wireless device, according to some embodiments.

FIG. 5 illustrates an example of a UWB direct acquisition signaling, according to some embodiments.

FIG. 6 illustrates an example diagram of a UWB ranging traffic pattern, according to some embodiments.

FIGS. 7a and 7b illustrate an example of Wi-Fi and UWB channels and frequency bands, according to some embodiments.

FIG. 8 illustrates an example a communication scheme between multiple radios in a wireless device, according to some embodiments.

FIG. 9 illustrates an example of communication between radios in a wireless device for a radio coexistence scheme, according to some embodiments.

FIG. 10 illustrates an example of a request message for the radio coexistence scheme, according to some embodiments.

FIG. 11 illustrates an example of a response message for the radio coexistence scheme, according to some embodiments.

FIG. 12 illustrates an example of illustrating an activity timing diagram for a radio in a UE having a coexistence scheme, according to some embodiments.

FIG. 13 illustrates an example of a multi-link device diagram for Wi-Fi 7, according to some embodiments.

FIG. 14 illustrates an example of a flow chart depicting a method of operating two or more radios in a wireless device having different radio access technologies, according to some embodiments.

FIG. 15 illustrates an example of a flow chart depicting a method for ranging from a first wireless device having multiple radios to a second wireless device, according to some embodiments.

While the features described herein may be susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Terminology

The following is a glossary of terms used in this disclosure:

Memory Medium—Any of various types of non-transitory memory devices or storage devices. The term “memory medium” is intended to include an installation medium, e.g., a CD-ROM, floppy disks, or tape device; a computer system memory or random-access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic”.

Computer System (or Computer)—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

User Equipment (UE) (or “UE Device”)—any of various types of computer systems devices which are mobile or portable and which performs wireless communications. Examples of UE devices include mobile telephones or smart phones (e.g., iPhone™, Android™-based phones), portable gaming devices (e.g., Nintendo DS™, PlayStation Portable™, Gameboy Advance™, iPhone™), laptops, wearable devices (e.g., smart watch, smart glasses), PDAs, portable Internet devices, music players, data storage devices, other handheld devices, unmanned aerial vehicles (UAVs) (e.g., drones), UAV controllers (UACs), and so forth. In general, the term “UE” or “UE device” can be broadly defined to encompass any electronic, computing, and/or telecommunications device (or combination of devices) which is easily transported by a user and capable of wireless communication.

Wireless Device—any of various types of computer systems or devices that perform communications, where the communications can be wired or wireless. A communication device can be portable (or mobile) or may be stationary or fixed at a certain location. A wireless device is an example of a communication device. A UE is another example of a communication device.

Base Station—The term “Base Station”, also referred to as an evolved nodeB (eNB) or next generation NodeB (gNB) has the full breadth of its ordinary meaning, and at least includes a wireless communication station installed at a fixed location and used to communicate as part of a wireless telephone system or radio system.

Processing Element (or Processor)—refers to various elements or combinations of elements that are capable of performing a function in a device, such as a user equipment or a cellular network device. Processing elements may include, for example: processors and associated memory, portions or circuits of individual processor cores, entire processor cores, processor arrays, circuits such as an ASIC (Application Specific Integrated Circuit), programmable hardware elements such as a field programmable gate array (FPGA), as well any of various combinations of the above.

Wi-Fi—The term “Wi-Fi” has the full breadth of its ordinary meaning, and at least includes a wireless communication network or RAT that is serviced by wireless local area network (WLAN) access points and which provides connectivity through these access points to the Internet. Most modern Wi-Fi networks (or WLAN networks) are based on IEEE 802.11 standards and are marketed under the name “Wi-Fi”. A Wi-Fi (WLAN) network is different from a cellular network.

Channel—a medium used to convey information from a sender (transmitter) to a receiver. It should be noted that since characteristics of the term “channel” may differ according to different wireless protocols, the term “channel” as used herein may be considered as being used in a manner that is consistent with the standard of the type of device with reference to which the term is used. In some standards, channel widths may be variable (e.g., depending on device capability, band conditions, etc.). For example, LTE may support scalable channel bandwidths from 1.4 MHz to 20 MHz. In contrast, WLAN channels may be 22 MHz wide while Bluetooth channels may be 1 Mhz wide. Other protocols and standards may include different definitions of channels. Furthermore, some standards may define and use multiple types of channels, e.g., different channels for uplink or downlink and/or different channels for different uses such as data, control information, etc.

Band—The term “band” has the full breadth of its ordinary meaning, and at least includes a section of spectrum (e.g., radio frequency spectrum) in which channels are used or set aside for the same purpose.

3GPP Access—refers to accesses (e.g., radio access technologies) that are specified by the Third Generation Partnership Project (3GPP) standards. These accesses include, but are not limited to, GSM/GPRS, LTE, LTE-A, and/or 5G NR. In general, 3GPP access refers to various types of cellular access technologies.

Non-3GPP Access—refers any accesses (e.g., radio access technologies) that are not specified by 3GPP standards. These accesses include, but are not limited to, WiMAX, CDMA2000, Wi-Fi, WLAN, and/or fixed networks. Non-3GPP accesses may be split into two categories, “trusted” and “untrusted”: Trusted non-3GPP accesses can interact directly with an evolved packet core (EPC) and/or a 5G core (5GC) whereas untrusted non-3GPP accesses interwork with the EPC/5GC via a network entity, such as an Evolved Packet Data Gateway and/or a 5G NR gateway. In general, non-3GPP access refers to various types on non-cellular access technologies.

SAR limitation—Limits to safe exposure of radio frequency (RF) energy are regulated by government entities. The limits are given in terms of a unit referred to as the Specific Absorption Rate (SAR), which is a measure of the amount of radio frequency energy absorbed by the body when using a UE. In one example, in the United States a SAR level of 1.6 watts per kilogram (1.6 W/kg) is considered safe. In Europe, a SAR level of 2.0 W/kg is considered safe. A UE that is configured to meet a set limit can be design to limit RF output power of all combined RAT signals that are transmitted concurrently to be below the SAR level. Accordingly, the limit also affects the combined output of RATs, and not just the output of a single RAT.

Ultra-Wideband (UWB)—The term “UWB” has the full breadth of its ordinary meaning, and at least includes a RAT that is configured to operate based on a UWB standard, including but not limited to the IEEE 802.15.4-2020 and IEEE 802.15.4z-2020 standards.

Automatically—refers to an action or operation performed by a computer system (e.g., software executed by the computer system) or device (e.g., circuitry, programmable hardware elements, ASICs, etc.), without user input directly specifying or performing the action or operation. Thus, the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system can update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

Approximately—refers to a value that is almost correct or exact. For example, approximately may refer to a value that is within 1 to 10 percent of the exact (or desired) value. It should be noted, however, that the actual threshold value (or tolerance) may be application dependent. For example, in some embodiments, “approximately” may mean within 0.1% of some specified or desired value, while in various other embodiments, the threshold may be, for example, 2%, 3%, 5%, and so forth, as desired or as used by the particular application.

Concurrent—refers to parallel execution or performance, where tasks, processes, or programs are performed in an at least partially overlapping manner. For example, concurrency may be implemented using “strong” or strict parallelism, where tasks are performed (at least partially) in parallel on respective computational elements, or using “weak parallelism”, where the tasks are performed in an interleaved manner, e.g., by time multiplexing of execution threads.

Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112 (f) interpretation for that component.

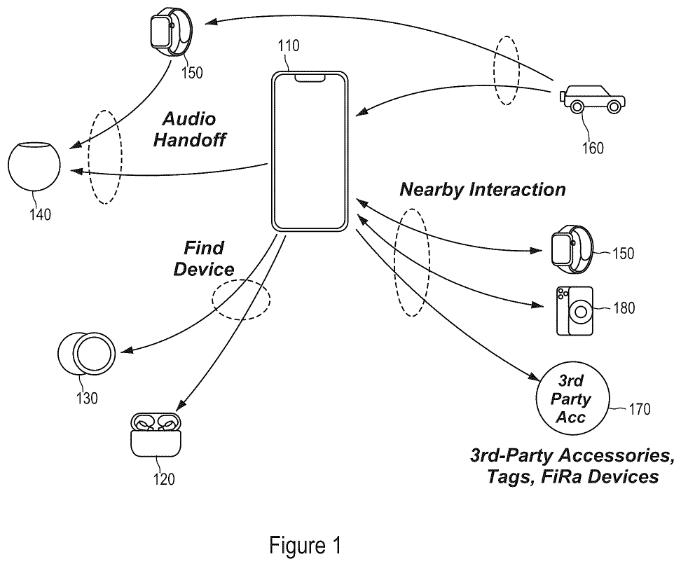

### FIG. 1—UWB Equipped Devices

FIG. 1 is a simplified block diagram of example UWB-equipped devices, according to some embodiments. In some embodiments, various types of Ultra-Wideband (UWB) devices may be improved, at least with respect to operating range, operating efficiency, and/or other feature enhancements. In some embodiments described herein, narrowband (NB) transmissions can be used in conjunction with UWB transmissions to effectively perform time-of-flight (TOF), ranging, and communication via the UWB transmissions over a greater distance.

Due to its large bandwidth (BW) of 500 MHz or more, one beneficial use case of UWB is that of “ranging.” In some embodiments, ranging may correspond to the precise measurement of the time-of-flight (TOF) of the radio waves between two UWB-equipped devices A and B, and the estimation of the distance (e.g., the “range”) between these devices. The large BW may help to resolve dense electromagnetic reflections that may be present in the vicinity of the devices, such as floors, ceilings, walls, furniture, cars, plants, appliances, or other human-made or natural objects in indoor and/or outdoor environments. Measuring the ToF/Range between devices such as mobile phones, wireless audio speakers, TV's, desktop or laptop computers, door locks for homes or cars, or other consumer devices may be beneficial to enable novel user experiences.

FIG. 1 illustrates scenarios with UWB-equipped devices. In diagram 100 of FIG. 1, a mobile device 110 communicates with other mobile, stationary, or Internet-of-Things (IoT) devices to measure distances or other positioning metrics, such as directions of appearance of devices with respect to each other. Devices involved in such communication can include phones (e.g., mobile device 110, 180), tags 130, wireless speakers (e.g., wireless speakers 120, 140), vehicles (e.g. digital car key 160) and/or third-party accessories 170. This example is not intended to be limiting. Additional UWB communications may be performed with, e.g., television sets, displays, door locks, home appliances, thermostats, desktop and/or laptop computers, tablet computers, and so forth. In the example of FIG. 1, the mobile device 110 can use UWB to perform an audio handoff with a speaker 140, unlock a car door using a digital key 160, or perform interactions with nearby devices, such as a watch 150, another mobile device 180, or third-party accessories 170. In addition, UWB can be used to help find devices, such as tags 130 and/or earbuds 120. Similarly, other types of UEs, such as a watch, can also be configured to use UWB for audio handoff, as a digital key, or to interact with nearby devices.

As shown, the exemplary wireless communication system includes a (“first”) wireless device 110 in communication with other (“second”) wireless devices, such as 150, 180, etc. The first wireless device 102 and the second wireless devices may communicate wirelessly using any of a variety of wireless communication techniques.

As one possibility, the first wireless device 110 and a second wireless device, such as device 150 or 180 may communicate using techniques based on wireless personal area network (WPAN) and/or wireless local area network (WLAN) wireless communication standards, such as 802.11/Wi-Fi. One or both of the wireless device 110 and the wireless devices 150, 180 may also be capable of communicating via one or more additional wireless communication protocols, such as UWB as described herein, and/or any of Bluetooth (BT), Bluetooth Low Energy (BLE), near field communication (NFC), LTE, LTE-Advanced (LTE-A), 5G NR, etc.

Each of the wireless devices 110, 150, 180 may be any of a variety of types of wireless device. As one possibility, one or more of the wireless devices 110, 150, 180 may be a substantially portable wireless device, such as a smart phone or user equipment (UE), a hand-held device, a wearable device, a tablet, a motor vehicle, or virtually any other type of mobile wireless device. As another possibility, one or more of the wireless devices 110, 150, 180 may be a substantially stationary device, such as a set top box, a media player (e.g., an audio or audiovisual device), a gaming console, a desktop computer, an appliance, a door lock, a base station, an access point, a beacon, or any of a variety of other types of device.

Each of the wireless devices 110, 150, 180 may include wireless communication circuitry configured to facilitate the performance of wireless communication, which may include various digital and/or analog radio frequency (RF) components, a processor that is configured to execute program instructions stored in memory, a programmable hardware element such as a field-programmable gate array (FPGA), programmable logic device (PLD), application specific integrated circuit (ASIC) and/or any of various other components. The wireless device 110 and/or the wireless devices 150, 180 may perform any of the method embodiments described herein, or any portion of any of the method embodiments described herein, using any or all of such components.

Each of the wireless devices 110, 150, 180 may include one or more antennas for communicating using one or more wireless communication protocols. In some cases, one or more parts of a receive and/or transmit chain may be shared between multiple wireless communication standards. For example, a device might be configured to communicate using any of UWB, Bluetooth, and/or Wi-Fi using partially or entirely shared wireless communication circuitry (e.g., using a shared antenna and/or shared radio components). The shared communication circuitry may include a single antenna, or may include multiple antennas (e.g., for MIMO) for performing wireless communications. Alternatively, a device may include separate transmit and/or receive chains (e.g., including separate antennas and other radio components) for two or more wireless communication protocols with which it is configured to communicate. As a further possibility, a device may include one or more radios or radio components which are shared between multiple wireless communication protocols, and one or more radios or radio components which are used exclusively by a single wireless communication protocol. For example, a device might include a shared radio for communicating using either of LTE or 5G NR, and separate radios for communicating using each of UWB, Wi-Fi, and/or Bluetooth. Other configurations are also possible.

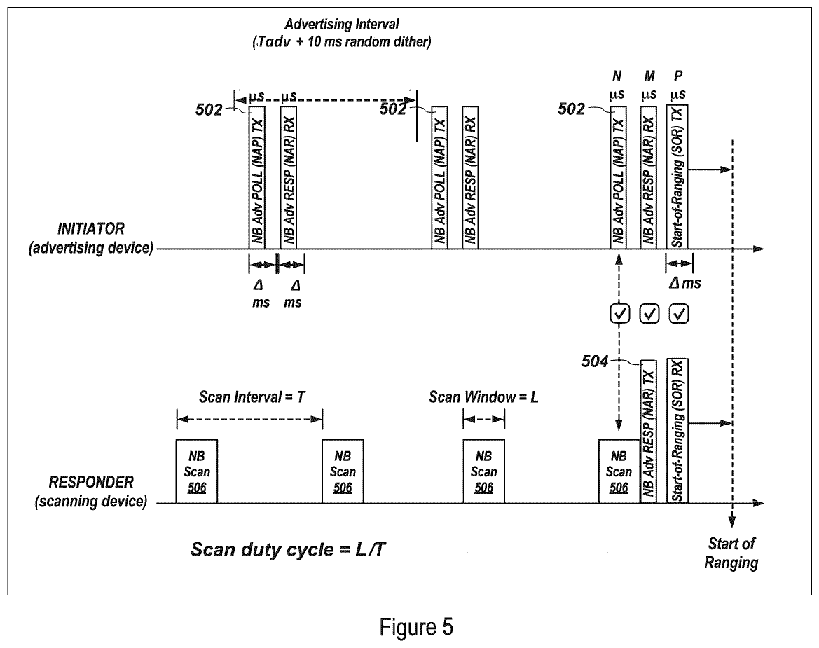

As previously noted, aspects of this disclosure may be implemented in conjunction with the wireless communication system of FIG. 1. For example, the wireless devices 110, 150, 180 may communicate using one or more coexistence techniques or features described subsequently herein with respect to FIGS. 5-13. By utilizing such techniques (and/or other techniques described herein), the wireless device(s) may (at least according to some embodiments) be able to increase range, and reduce interference and/or congestion, while communicating according to a plurality of wireless communication technologies.

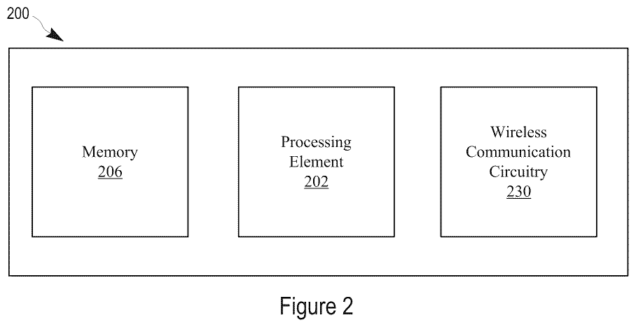

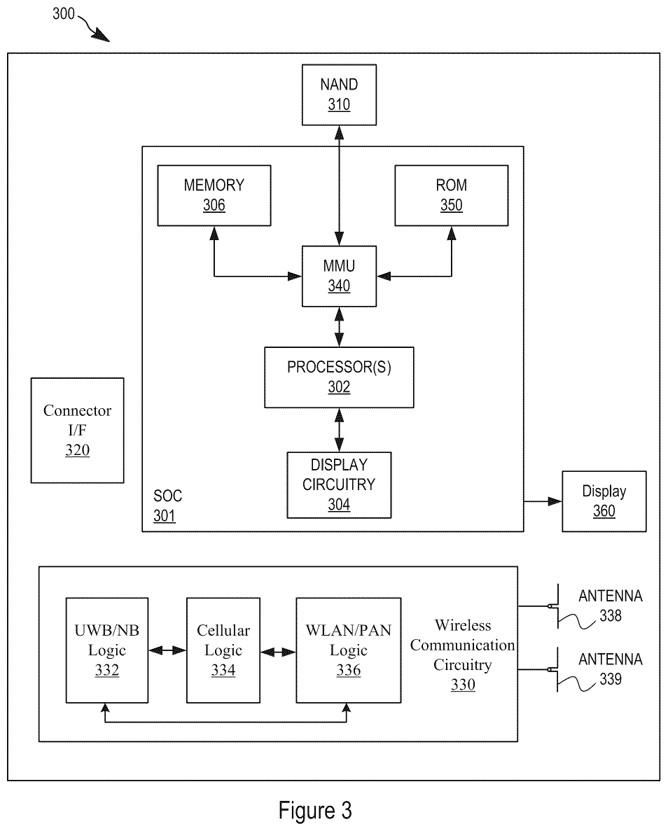

### FIGS. 2-3—Exemplary Device Block Diagrams

FIG. 2 illustrates an exemplary wireless device 200 that may be configured for use in conjunction with various aspects of the present disclosure. For example, the device 200 may be an example of the wireless device 110 or the wireless device 150. The device 200 may be any of a variety of types of device and may be configured to perform any of a variety of types of functionality. The device 200 may be a substantially portable device or may be a substantially stationary device, potentially including any of a variety of types of device. The device 200 may be configured to perform one or more wireless communication coexistence techniques or features, such as any of the techniques or features illustrated and/or described subsequently herein with respect to any or all of FIGS. 5-13.

As shown, the device 200 may include a processing element 202. The processing element may include or be coupled to one or more memory elements. For example, the device 200 may include one or more memory media (e.g., memory 206), which may include any of a variety of types of memory and may serve any of a variety of functions. For example, memory 206 could be RAM serving as a system memory for processing element 202. Other types and functions are also possible.

Additionally, the device 200 may include wireless communication circuitry 230. The wireless communication circuitry may include any of a variety of communication elements (e.g., antenna for wireless communication, analog and/or digital communication circuitry/controllers, etc.) and may enable the device to wirelessly communicate using one or more wireless communication protocols.

Note that in some cases, the wireless communication circuitry 230 may include its own processing element (e.g., a baseband processor and/or control processor), e.g., in addition to the processing element 202. For example, the processing element 202 might be (or include) an ‘application processor’ whose function may include supporting application layer operations in the device 200, while the wireless communication circuitry 230 might include a ‘baseband processor’ (or functionally similar component(s)) whose function may include supporting baseband layer operations (e.g., to facilitate wireless communication between the device 200 and other wireless devices) in the device 200. In other words, in some cases the device 200 may include multiple processing elements (e.g., may be a multi-processor device). Other configurations (e.g., instead of or in addition to an application processor/baseband processor configuration) utilizing a multi-processor architecture are also possible.

The device 200 may include any of a variety of other components (not shown) for implementing device functionality, depending on the intended functionality of the device 200, which may include further processing and/or memory elements (e.g., audio processing circuitry), one or more power supply elements (which may rely on battery power and/or an external power source), user interface elements (e.g., display, speaker, microphone, camera, keyboard, mouse, touchscreen, etc.), sensors, and/or any of various other components.

The components of the device 200, such as processing element 202, memory 206, and wireless communication circuitry 230, may be operatively coupled via one or more interconnection interfaces, which may include any of a variety of types of interface, possibly including a combination of multiple types of interface. As one example, a universal serial bus (USB) high-speed inter-chip (HSIC) interface may be provided for inter-chip communications between processing elements. Alternatively (or in addition), a universal asynchronous receiver transmitter (UART) interface, a serial peripheral interface (SPI), inter-integrated circuit (I2C), system management bus (SMBus), and/or any of a variety of other communication interfaces may be used for communications between various device components. Other types of interfaces (e.g., intra-chip interfaces for communication within processing element 202, peripheral interfaces for communication with peripheral components within or external to device 200, etc.) may also be provided as part of device 200.

FIG. 3 illustrates one possible block diagram of a wireless device 300, which may be one possible exemplary implementation of the device 200 illustrated in FIG. 2. As shown, the wireless device 300 may include a system on chip (SOC) 301, which may include portions for various purposes. For example, as shown, the SOC 301 may include processor(s) 302 which may execute program instructions for the wireless device 300, and display circuitry 304 which may perform graphics processing and provide display signals to the display 360. The SOC 301 may also include motion sensing circuitry 370, which may detect motion of the wireless device 300, for example using a gyroscope, accelerometer, and/or any of various other motion sensing components. The processor(s) 302 may also be coupled to memory management unit (MMU) 340, which may be configured to receive addresses from the processor(s) 302 and translate those addresses to locations in memory (e.g. memory 306, read only memory (ROM) 350, flash memory 310). The MMU 340 may be configured to perform memory protection and page table translation or set up. In some embodiments, the MMU 340 may be included as a portion of the processor(s) 302.

As shown, the SOC 301 may be coupled to various other circuits of the wireless device 300. For example, the wireless device 300 may include various types of memory (e.g., including NAND flash 310), a connector interface 320 (e.g., for coupling to a computer system, dock, charging station, etc.), the display 360, and wireless communication circuitry 330 (e.g., for UWB, LTE, LTE-A, 5G NR, Bluetooth, Wi-Fi, NFC, GPS, etc.).

The wireless device 300 may include at least one antenna, and in some embodiments multiple antennas 338 and 339, for performing wireless communication with base stations and/or other devices. For example, the wireless device 300 may use antennas 338 and 339 to perform the wireless communication. In some implementations, each of the antennas 338 or 339 may include one or more antennas and/or one or more antenna arrays. As noted above, the wireless device 300 may, in some embodiments, be configured to communicate wirelessly using a plurality of wireless communication standards or radio access technologies (RATs).

The wireless communication circuitry 330 may include UWB Logic 332, Cellular Logic 334, and additional WLAN/PAN Logic 336. The UWB Logic 332 is for enabling the wireless device 300 to perform UWB communications, e.g., for wireless communications as described herein. The UWB Logic 332 can also include NB logic for enabling the wireless device 300 to communicate NB signals that can be used to establish, maintain, and/or coordinate UWB connections with other wireless devices. While the NB Logic is illustrated as being combined with the UWB Logic 332 in the example of FIG. 3, this is not intended to be limiting. The NB Logic may be separate from the UWB Logic 332. In some implementations, the NB logic may be combined with the WLAN/PAN Logic 336. In some other implementations, both the UWB Logic 332 and the WLAN/PAN Logic 336 can be configured to communicate one or more NB signals that may be used to establish, maintain, and/or coordinate UWB connections with other wireless devices. The WLAN/PAN Logic 336 is for enabling the wireless device 300 to perform other WLAN and/or PAN communications, such as Wi-Fi and/or Bluetooth communications. In some scenarios, the WLAN/PAN Logic 336 may include distinct circuitry for performing communications according to distinct protocols, such as a first portion of circuitry for performing Wi-Fi communications and a second portion of circuitry for performing Bluetooth communications. In some scenarios, the WLAN/PAN Logic 336 main also, or alternatively, include shared circuitry for performing communications according to multiple protocols, such as both Wi-Fi and Bluetooth. The Cellular Logic 334 may be capable of performing cellular communication according to one or more cellular communication technologies. In some scenarios, each of the UWB Logic 332, the Cellular Logic 334, and the WLAN/PAN Logic 336, or some portion thereof may be referred to as a radio. For example, the UWB Logic 332 may be referred to as, or may include, a UWB radio and a NB radio; the Cellular Logic 334 may be referred to as, or may include, a cellular radio; and/or the WLAN/PAN Logic 336 may be referred to as, or may include, one or more of a WLAN radio, a PAN radio, a Wi-Fi radio, a BT radio, etc.

Note that in some cases, one or more of the UWB/NB Logic 332, the Cellular Logic 334, and/or the WLAN/PAN Logic 336 may include its own processing element (e.g., a baseband processor, control processor, or functionally similar components), e.g., in addition to the processor(s) 302. For example, the processor(s) 302 might be (or include) an ‘application processor’ that functions to support application layer operations in the device 300, while one or more of the UWB/NB Logic 332, the Cellular Logic 334, and/or the WLAN/PAN Logic 336 may include a baseband processor that functions to support baseband layer operations for the applicable RAT.

As described herein, wireless device 300 may include hardware and software components for implementing embodiments of this disclosure. For example, one or more components of the wireless communication circuitry 330 (e.g., UWB/NB Logic 332 and/or WLAN/PAN Logic 336) of the wireless device 300 may be configured to implement part or all of the methods described herein, e.g., by a processor executing program instructions stored on a memory medium (e.g., a non-transitory computer-readable memory medium), a processor configured as an FPGA (Field Programmable Gate Array), and/or using dedicated Al hardware components, which may include an ASIC (Application Specific Integrated Circuit).

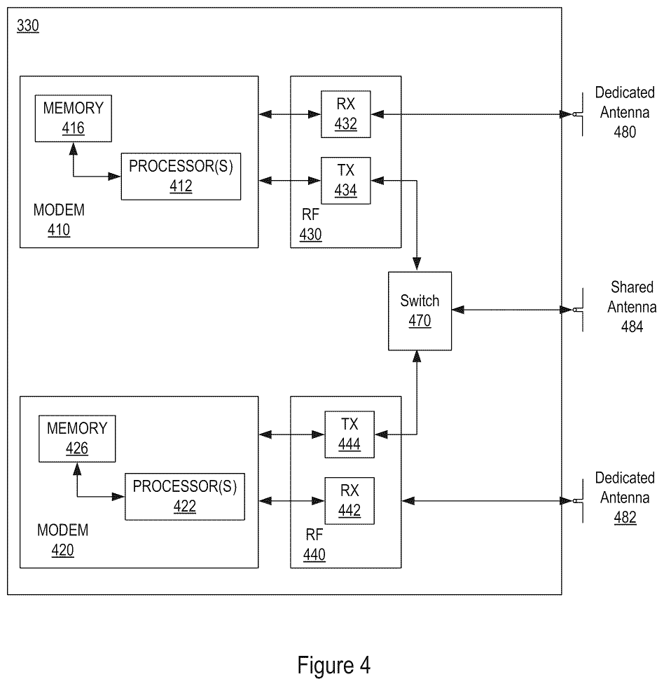

### FIG. 4—Block Diagram of Wireless Communication Circuitry

FIG. 4 illustrates an example simplified block diagram of wireless communication circuitry, according to some embodiments. It is noted that the block diagram of the wireless communication circuitry of FIG. 4 is only one example of a possible wireless communication circuit; other circuits, such as circuits including or coupled to sufficient antennas for different RATs to perform communication activities using separate antennas, or circuits including or coupled to fewer antennas, e.g., that may be shared among multiple RATs, are also possible. According to some embodiments, wireless communication circuitry 330 may be included in a communication device, such as communication device 102 described above.

The wireless communication circuitry 330 may couple (e.g., communicatively; directly or indirectly) to one or more antennas, such as antennas 480, 482, and 484, as shown, which may be equivalent to, or included in the set of antennas 338 and 339 of FIG. 3. In some embodiments, wireless communication circuitry 330 may include dedicated receive chains (including and/or coupled to (e.g., communicatively; directly or indirectly) dedicated processors and/or radios) for multiple RATs (e.g., a first receive chain for UWB and a second receive chain for Wi-Fi). For example, as shown in FIG. 4, wireless communication circuitry 330 may include a first modem 410 and a second modem 420. The first modem 410 may be configured for communications according to a first RAT, such as UWB, and the second modem 420 may be configured for communications according to a second RAT, such as Wi-Fi.

As shown, the first modem 410 may include one or more processors 412 and a memory 416 in communication with processors 412. Modem 410 may be in communication with a radio frequency (RF) front end 430. RF front end 430 may include circuitry for transmitting and receiving radio signals. For example, RF front end 430 may include receive circuitry (RX) 432 and transmit circuitry (TX) 434. In some embodiments, RF front end 430 may be communicatively coupled to dedicated antenna 480, which may be used exclusively by the modem 410. In some scenarios, dedicated antenna 480 may include a plurality of antennas, or one or more antenna arrays.

Similarly, the second modem 420 may include one or more processors 422 and a memory 426 in communication with processors 422. Modem 420 may be in communication with an RF front end 440. RF front end 440 may include circuitry for transmitting and receiving radio signals. For example, RF front end 440 may include receive circuitry 442 and transmit circuitry 444. In some embodiments, RF front end 440 may be communicatively coupled to dedicated antenna 482, which may be used exclusively by the modem 420. In some scenarios, dedicated antenna 482 may include a plurality of antennas, or one or more antenna arrays.

In some embodiments, a switch 470 may couple RF front end 430 to shared antenna 484. In some scenarios, shared antenna 484 may include a plurality of antennas, or one or more antenna arrays. In addition, switch 470 may couple RF front end 440 to shared antenna 484. Thus, when wireless communication circuitry 330 receives instructions to transmit and/or receive according to the first RAT (e.g., as supported via the first modem 410), switch 470 may be switched to a first state that allows the first modem 410 to transmit and/or receive signals according to the first RAT (e.g., via a communication chain that includes RF front end 430 and shared antenna 484). Similarly, when wireless communication circuitry 330 receives instructions to transmit and/or receive according to the second RAT (e.g., as supported via the second modem 420), switch 470 may be switched to a second state that allows the second modem 420 to transmit and/or receive signals according to the second RAT (e.g., via a communication chain that includes RF front end 440 and shared antenna 484). In some scenarios, wireless communication circuitry 330 may receive instructions to transmit or receive according to both the first RAT (e.g., as supported via modem 410) and the second RAT (e.g., as supported via modem 420) simultaneously. In such scenarios, switch 470 may be switched to a third state that allows modem 410 to transmit and/or receive signals according to the first RAT (e.g., via a communication chain that includes RF front end 430 and shared antenna 484) and modem 420 to transmit signals according to the second RAT (e.g., via a communication chain that includes RF front end 440 and shared antenna 484). In other scenarios, simultaneous transmission of signals according to both RATs via the shared antenna 484 may not be allowed.

In some embodiments, the RF front end 430 may select between transmitting via the shared antenna 484 or the dedicated antenna 480. Similarly, the RF front end 440 may select between transmitting via the shared antenna 484 or the dedicated antenna 482. Such selections may be based on a variety of factors, such as transmission frequency of the communications, ongoing use of the shared antenna 484 by the other RF front end, antenna diversity considerations, and/or other operational considerations, e.g., as discussed below.

As described herein, the first modem 410 and/or the second modem 420 may include hardware and software components for implementing any of the various features and techniques described herein. The processors 412, 422 may be configured to implement part or all of the features described herein, e.g., by executing program instructions stored on a memory medium (e.g., a non-transitory computer-readable memory medium). Alternatively (or in addition), processors 412, 422 may be configured as a programmable hardware element, such as an FPGA (Field Programmable Gate Array), or as an ASIC (Application Specific Integrated Circuit). Alternatively (or in addition) the processors 412, 422, in conjunction with one or more of the other components 430, 432, 434, 440, 442, 444, 470, 480, 482, and 484 may be configured to implement part or all of the features described herein.

In addition, as described herein, processors 412, 422 may include one or more processing elements. Thus, processors 412, 422 may include one or more integrated circuits (I Cs) that are configured to perform the functions of processors 412, 422. In addition, each integrated circuit may include circuitry (e.g., first circuitry, second circuitry, etc.) configured to perform the functions of processors 412, 422.

In some embodiments, the wireless communication circuitry 330 may couple to only a subset of the antennas 480, 482, and 484. For example, in some scenarios, dedicated antenna 480 and/or dedicated antenna 482 may be omitted. In some embodiments, the wireless communication circuitry 330 may couple to only the shared antenna 484.

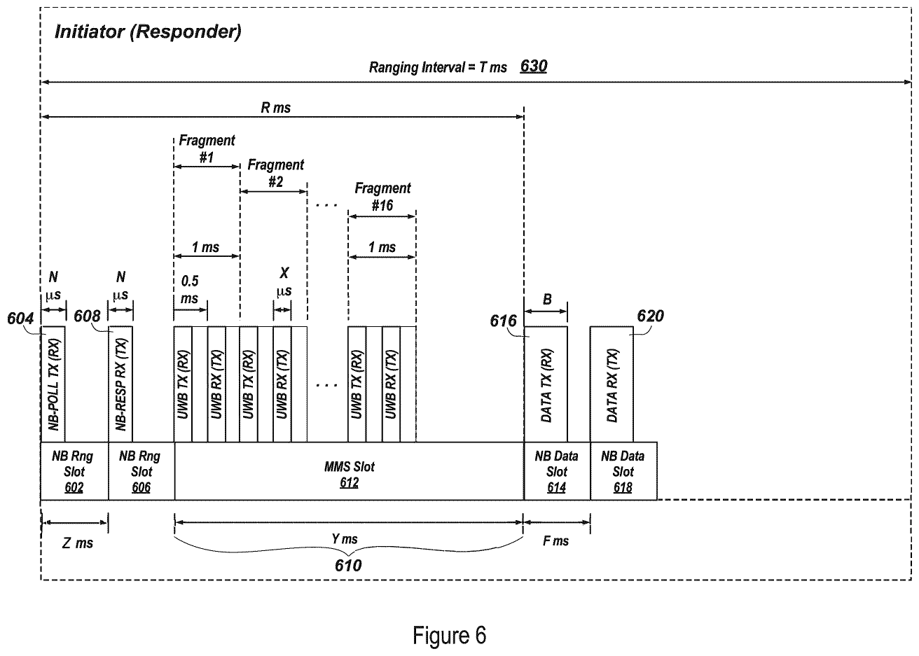

### FIGS. 5 and 6—UWB/NB Signaling

In some embodiments described herein, a hybrid wireless system can be utilized, in which NB signaling and UWB signaling are combined to improve operating efficiency and/or operating range of UWB systems. In some embodiments, systems that perform NB signaling may include wireless systems that have a bandwidth significantly smaller than that of UWB. In some embodiments, UWB may have a minimum bandwidth of 500 MHz, so NB may refer to systems exhibiting a fraction of that bandwidth, such as, for example, a NB bandwidth of several hundred kHz, 1 MHz, or 10-20 MHz. Some non-limiting examples of NB systems would be NB GFSK (Gaussian Frequency Shift Keying) or DPSK (Differential Phase Shift Keying) signaling as utilized in Bluetooth or IEEE 802.15.4z-2020 O-QPSK (Offset Quadrature Phase-Shift Keying format) as used in such industry standards as ZigBee or Thread. More NB modes in wireless local area networks (WLANs), such as IEEE 802.11 modes spanning 20 or 40 MHz of spectral bandwidth, may also be classified as NB signaling in the context of this disclosure as they have significantly lower bandwidth than UWB and tend to operate in different frequency spectra. In some embodiments, they are also regulated by a different set of regulatory constraints than UWB.

International regulatory rules governing UWB deployments and associated radiated emissions may define low emissions limits for UWB devices, as the devices that employ UWB tend to operate in spectral bands that are below 10 Gigahertz (GHz). These spectral bands used for UWB communications are primarily targeted for the use of licensed or restricted commercial or military operation of point-to-point or satellite links, radars, or other protected applications. Hence UWB emissions may be relegated to operate at the spurious emission levels allowed for other electronic devices (e.g., mobile devices, household devices, etc.) so that the UWB communications do not interfere with such licensed or restricted uses. To limit potential interference, transmit powers for UWB may be limited to less than −10 dBm on the average in many regions.

In contrast, a variety of more NB systems and associated regulatory rules exist for bands that are designated to operate for unlicensed uses. These NB systems typically have significantly looser emissions limits. The 2.4-2.5 GHz so-called ISM (Industrial, Scientific, Medical) band is a prime example that accommodates NB applications such as 1 or 2 MHz wide Bluetooth (BT) or ZigBee/Thread transmissions, or Wireless Local Area Networks (WLANs) with bandwidths in the 20 MHz or 40 MHz regimes. The 2.4-2.5 GHz band used for Bluetooth Low Energy (BLE) is an example for a band available in most regulatory regions world-wide. There are other ISM-like spectra that, in many countries, include the 5.725-5.875 GHz band. Other spectra, including large parts of the 5-6 GHz bands, are also often open for various license-free, non-UWB uses, under certain conditions. Transmit powers (radiation levels) of these more NB systems are often in the 10 dBm, 20 dBm, or even 30 dBm region.

UWB, with its large bandwidth (500 MHz, 1 GHz or beyond), is particularly advantageous for advanced ranging & sensing applications where precise measurements of the propagation channel between associated devices allow extraction of such metrics as the Time-of-Flight (ToF) and corresponding distance between devices. However, the limited emissions pose a challenge to the operating range. By contrast, the higher transmit/transmission (Tx) powers of NB systems allow better operating range but fall short on the potential to do high-accuracy estimation due to their more limited bandwidth.

In accordance with one embodiment, wireless devices, such as devices 110 and 180 in FIG. 1, can include NB radios, using a NB RAT, that can be used to perform NB communication between two devices. The NB communications can be used to transmit and receive data, synchronize the devices and perform scheduling for UWB communication by the UWB radios. The UWB radios can then be used, for example, to perform ranging and location finding using the UWB RAT.

### FIGS. 5 and 6—NB and UWB Signaling

FIG. 5 illustrates an example of direct acquisition between a first device, referred to as an initiator, and a second device, referred to as a responder. The NB and UWB signaling may be performed according to a ranging protocol, involving bi-directional NB and UWB signaling between the first device (e.g. device 110) and the second device (e.g. device 180). The two devices may first perform an initial phase, during which there may be an initial device discovery and an initial (e.g., “coarse”) synchronization between the two devices. In some examples, this initial phase may be performed by a wireless system of each device, for example, that is equipped to transmit wireless signals using a NB radio, such as a Bluetooth radio configured for Bluetooth Low Energy (BLE) or another NB radio configuration. The NB radio configuration will be discussed further in the proceeding paragraphs.

During this initial phase, the wireless system of the first device, referred to as the initiator, may advertise its presence by transmitting a periodic NB advertising (adv) poll (NAP) packet 502 having a transmission duration of N microseconds, where N is a positive number. The NAP packet 502 can be sent at a scheduled start time (e.g., a discrete time instant) within an advertising interval. In this example, the advertising interval is approximately Tadv ms, with a 10 ms random dither, where Tadv can be from 10 ms to 50 ms. In other examples, other values can be used. In this example, the advertising interval repeats every Tadv ms. The NAP packet 502 transmission can be transmitted by the first device within the repeated advertising intervals. The second device, referred to as a responder, can scan for a signal over a NB scan window 506 with a length of time denoted as L. In this example, L can be from 1 to 6 ms. A scan interval can be repeated over a time period, T. In this example, the scan interval T has a length that is the same as the advertising interval, with T ranging from 15 to 60 ms. Accordingly, one scan duty cycle, L/T, 6 ms/60 ms in this example, is approximately 10%. This is not intended to be limiting. The advertising interval, scan interval T, and scan window L can be selected based upon desired system power and responsiveness. The first device can continue to transmit a NAP packet within each advertising interval, while the second device can continue to scan over an NB scan window 506 within each scan interval until the scan window 506 time period of the second device aligns with the NAP packet 502 transmitted by the first device.

The first device (e.g. initiator) is scheduled to receive a NB adv response (NAR) packet 504 a set time after the NAP packet is transmitted. The NAP packet can have a transmission duration of M microseconds, where M is a positive number. The NAR packet 504 is transmitted by the second device (e.g. responder) when a NAP packet 502 is received by the second device during the NB scan window 506, as illustrated in FIG. 5. When the NAR packet is received by the first device (e.g. initiator), the first device transmits a start-of-ranging (SOR) packet 508 to the second device. The SOR packet 508 can include timing information for the first device and second device to begin a ranging procedure according to a protocol, along with coarse synchronization information between the first device and the second device. In one embodiment the ranging procedure can involve frequency hopping (FH). To accommodate FH, the SOR packet can include a seed with information for a random sequence to be generated by both devices for the FH, and a time offset from the SOR packet until the time when ranging is to be started. The SOR packet can have a transmission duration of P microseconds. The time period between the start of the NAP packet 502 and the start of the NAR packet 504 and the start of the SOR packet 506 can be greater than 1 millisecond. The transmission duration of the 502, 504 and 506 is typically less than 1 millisecond and can be less than 600 microseconds.

FIG. 6 illustrates one example of a ranging protocol. In this example, the first radio can schedule a time period from information received in the SOR packet 508 (FIG. 5). The time period is referred to as an NB range slot 602. The time period can be Z milliseconds, where Z is a positive integer. An exemplary time period can be from 0.25 milliseconds to 2.5 milliseconds. During the NB range slot 602, the first radio can transmit at least one packet, an “NB-poll” packet 604 to the second device, referred to as the responder, via an NB signal. The first device may also schedule an additional window, via the SOR packet 508 (FIG. 5), a time interval also referred to as a NB range slot 606, for subsequent reception of a second packet, an “NB-response” packet 608 that is transmitted via another NB signal transmitted to the first device from the second device.

Following this initial phase, the first device may then transmit the scheduled NB poll packet 604 to the second device at the scheduled start time via the NB signal, whereby the packet 604 may convey (e.g., indicate) one or more types of synchronization data to be used for a second (e.g., “fine”) synchronization between the two devices. For example, the packet may include a synchronization (“sync”) field. The second device may extract a type of synchronization data from the sync field that corresponds to time and frequency synchronization information (e.g., T/F sync information) by using state-of-the-art synchronization and/or signal acquisition techniques. The second device may also extract another type of synchronization data from the data payload field that corresponds to scheduling data by using state-of-the-art demodulation and decoding techniques. The synchronization data may be used by the second device to schedule and assist in the reception of a plurality of data fragments 610 to be subsequently transmitted by the first device to the second device via UWB signals in short bursts and distributed over multiple intervals, referred to as multiple milliseconds (MMS), that can be transmitted in an MMS slot 612. In this example, the scheduling data of the NB-poll 602 may also include scheduling information regarding the NB response packet transmission start time, enabling the second device to schedule transmission of the NB response packet 608 to the first device at the NB response start time. The second device may subsequently transmit the NB response packet 608 at the desired start time, whereby the NB response packet conveys second synchronization data, similar to as described above with respect to the synchronization data from the first device to the second device. This second synchronization data may be used by the first device to schedule and assist in the reception of a second plurality of fragments that may be subsequently transmitted by the second device to the first device via UWB signals distributed over multiple intervals. In this way, NB-signaling layers of each device may assist the respective UWB-signaling layers in synchronization and other functions. The duration of the MMS slot period can be Y milliseconds, where Y is a positive number. A typical value of Y can be between 16 ms and 50 ms. Note that the assistance in the reception of the UWB signals derived from the synchronization data conveyed via the NB signals may comprise configuration of the UWB receptions in terms of carrier frequency and sample frequency offsets relative to the respective associated (second or first) device.

The first device may then schedule and transmit the plurality of UWB fragments, illustrated as UWB TX (RX) in FIG. 6, to the second device for reception at the second device according to the synchronization data that was previously obtained by the second device from the first device. In this example, the plurality of UWB data fragments may collectively represent a Channel Impulse Response Training Sequence (CIRTS) of a UWB-formatted packet. Upon receipt of the CIRTS from the first device (e.g., via aggregating the fragments), the second device may use the CIRTS to estimate a Channel Impulse Response (CIR) and/or determine other synchronization information (e.g., time and frequency information, scheduling data, etc.). After a turnaround time interval, which, in this example, may be a fixed time interval that is known by the first device, the second device may then, correspondingly, schedule and transmit the second plurality of UWB fragments, illustrated as UWB RX (TX) in FIG. 6, to the first device for reception at the first device according to the second synchronization data that was previously obtained by the first device from the NB transmission of the second device. Alternatively, the UWB TX (RX) and UWB RX (TX) fragments may be interleaved, as illustrated in FIG. 6. The first device may then, similarly compute a CIR estimate and/or obtain other synchronization information. Then, utilizing computed CIR information, and, taking into account (e.g., subtracting) the turnaround time, the first device may determine a time-of-flight (TOF) that is associated with a Line-of-Sight (LOS) path between the two devices. Accordingly, the first device may then be able to determine a range and/or position of the first device with respect to the second device.

NB data slots 614, 618 can be scheduled after the MMS slot 612 for transmission of data packets 616 and 620 between the first device and the second device. The data payload field may include scheduling data (e.g., which also may be known as “scheduling information”). The data can be used to schedule future ranging intervals 630 between the first device and the second device. The transmission duration of the data packets can depend on the number of bytes of data transmitted. A typical value of B can be between 0.4 milliseconds and 2 milliseconds. A typical value of the duration of the NB data slot 614, 618 can be between 2 milliseconds and 4 milliseconds. The ranging interval can have a time of T milliseconds, where T is a positive number. A typical value of T can be between 50 and 150 milliseconds. The ranging protocol can be repeated at a selected frequency. The frequency can be selected to provide an updated range and position at a desired frequency, such as 10 Hz, 1 Hz, 0.1 Hz, 0.01 Hz, or another desired frequency. Devices designed to use very low power can use a lower frequency, such as once per hour or once per day, or when scheduled. The hybrid uses of NB and UWB signaling can be used to improve upon operating range and/or efficiency when performing ranging and/or positioning via UWB signaling. The NB packet duration and slot size are selected to minimize the impact to external radio concurrency. For ranging, a short slot size is used and NB radio packets are limited to allow a Wi-Fi radio access point (AP) to perform rate adaptation.

A similar approach to minimize the impact to other radios was taken in the design of the NB communication timeline. In adopting a low latency approach, a balance for coexistence between the NB radio and a Wi-Fi radio was found. The NB exchange that conveys the result of the UWB transmission in a selected channel, such as UWB channel 9, is sent by the NB radio in the Data Tx packet 616 at a 50 ms offset from the NB poll 604 transmission in the NB ranging slot 602. This time period, illustrated as R milliseconds, is selected to enable a Wi-Fi radio to recover from the NB radio disruptions without a noticeable impact to latency. This can be particularly important for peer to peer and low latency applications operating on the wireless device 110. The RF frequency of operation for the NB radio during the acquisition stage (FIG. 5) may also be adjusted to consider aggressor radios.

As previously discussed, the NB signals are transmitted with significantly higher power than the UWB signals. However, the UWB signals are transmitted multiple times over the MMS slot 612. This allows the UWB receiver to accumulate energy over N fragments transmitted during the MMS slot 612, which results in a 10*log (N) of link margin energy improvement, where N is a positive integer. In the example in FIG. 6, the UWB fragment is transmitted and received by the respective first device and the second device a total of 16 times. However, during the 49 ms MMS slot, it can be transmitted up to 49 times. Accordingly, the limiting factor in the NB/UWB ranging protocol link budget can be the power of the NB signal transmissions.

As previously discussed, the NB signal can be transmitted using a Bluetooth radio configured to operate with Bluetooth Low Energy (BLE), which operates in the 2.4 GHz to 2.5 GHz range. However, this range can be a very commonly used range in the ISM bands. A UE, such as the device 110, can have multiple radios transmitting. In order to keep the total transmitted RF power from the device to be less than a predetermined SAR level, the NB signal power transmitted with BLE in the 2.4 GHz range can be relatively low due to multiple radios operating concurrently. In addition, the popularity of the 2.4 GHz range can create a relatively high noise floor compared with other frequency ranges. The low power transmissions and relatively high noise floor when using BLE can limit the distance over which the devices of FIG. 1 can communicate using the NB signal to setup the UWB signal to perform ranging and location finding.

In accordance with one embodiment, an NB radio operating in another band, such as (but not limited to) an ISM band that enables higher power transmissions, can enable the NB signal to be transmitted with substantially higher power than a BLE transmission. This can significantly extend the distance over which the devices of FIG. 1 can communicate and perform ranging and location using an NB radio and a UWB radio. In one embodiment, the NB signal power can be raised sufficient to increase the distance by 2, 3, 4 or more times relative to a BLE NB transmission. The actual value of the NB signal power can depend on local regulations in different countries or regions. In one embodiment, the NB radio can be configured to transmit NB signals, such as the NB signals illustrated in FIGS. 5 and 6, in the Unlicensed National Information Infrastructure (UNII)-3 band from 5.725-5.875 GHz, using channels 149, 153, 157, 161 and 165. The NB signal can be a frequency hopping (FH) signal within the band. This example is not intended to be limiting. The NB signal can be transmitted, and frequency hopped, throughout a band that provides access in multiple countries and allows transmission powers greater than those used in BLE transmissions when accounting for SAR limitations.

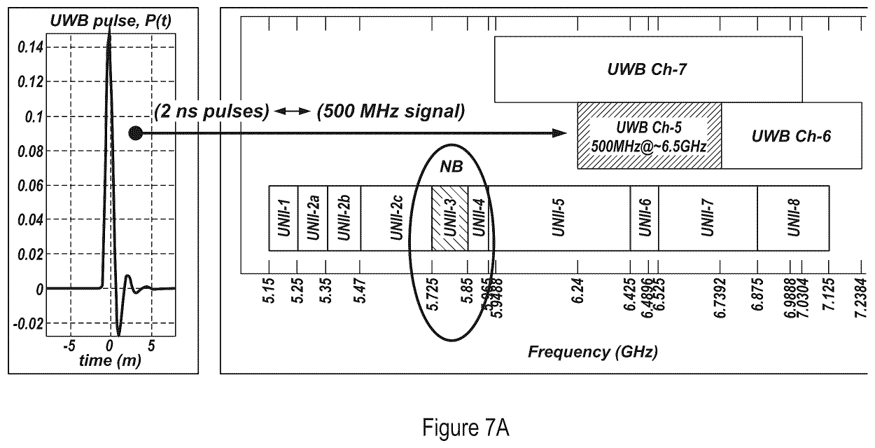

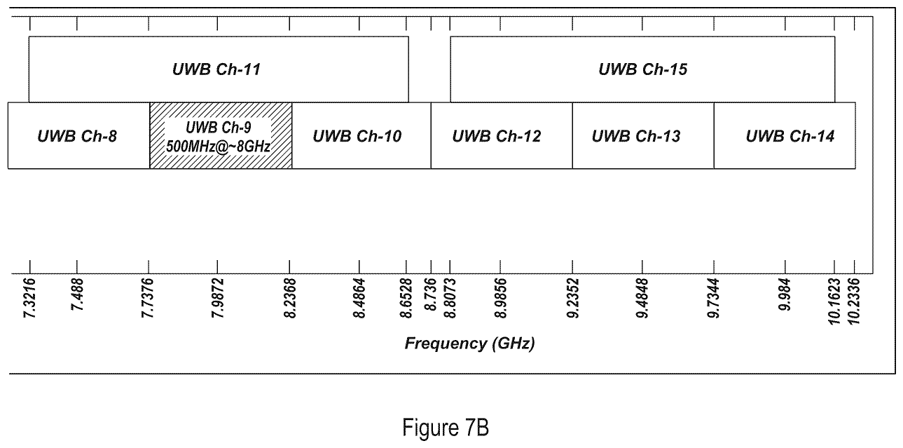

FIGS. 7a and 7b—UWB and Wi-Fi Communication Channels

FIGS. 7a and 7b provide an example illustration of UWB communication channels and Wi-Fi 6E bands that are used in the 5 GHz to 7.125 GHz range. These include the UNII-1, 2a, 2b, 2c, and 3-8 bands of the ISM. One challenge with transmitting and receiving an NB signal within these UNII bands is the potential interference with Wi-Fi 6E transmissions in these same bands, and the transmission of UWB in UWB channels 5, 6, and 7. In addition, communications by the UWB radio in UWB channels 8 and 9 and 11 may also have some interference with the upper UNII band 8 transmissions and Wi-Fi 6 GHz bands. Specifically, out-of-band signals due to intermodulation and the sum and difference frequencies due to the mixing of different RF signals can result in interference between an NB radio, a Wi-Fi radio, and a UWB radio communicating within the bands illustrated in FIGS. 7a and 7b. A coexistence scheme can be used to configure the Wi-Fi radio, UWB radio, NB radio, and other WLAN/PAN radios to communicate without substantial interference that may disrupt communication when two or more of the radios are operating simultaneously.

In accordance with one embodiment, a coexistence scheme is disclosed in which two or more radios in a wireless device are configured to communicate in real-time. In one example, the radios can communicate using a system power and management interface (SPMI). An SPMI is a high-speed, low-latency, bi-directional, two-wire serial bus suitable for real-time control of voltage and frequency scaled multi-core application processors and its power management of auxiliary components, such as the radios in a wireless device, in one example.

For example, returning to FIG. 3, the UWB/NB logic 332 can be coupled to the WLAN/PAN logic 336 using an SPMI to allow the radios to communicate in real time. More specifically, a UWB radio and an NB radio can be coupled to a Wi-Fi radio using the SPMI, to allow real-time communication between the radios.

In one embodiment, a notification can be communicated using, for example, SPMI when the NB radio is about to be activated to permit the Wi-Fi radio to only adjust a SAR budget for the Wi-Fi radio for the time period that the NB Transmit has been enabled, as part of the use case by the UWB radio. This preserves the SAR budget for the Wi-Fi radio in cases when the UWB radio and the NB radio are not enabled. This approach permits each radio to locally manage its SAR budget with a minimum of interaction between the radios to understand when a reduced platform SAR budget is in use by the Wi-Fi radio.

The coexistence scheme may be implemented by any appropriate system, such as a wireless device, e.g., the wireless device 110, or some portion thereof, such as by an application processor (e.g., processor(s) 302) or the wireless communication circuitry 330 (e.g., the UWB/NB Logic 332 and/or the WLAN/PAN Logic 336 and/or cellular logic 334). For example, in some scenarios, software executed by the UWB/NB Logic 332 may communicate with software executed by the WLAN/PAN Logic 336 and/or software executed by the processor(s) 302, e.g., to share information regarding use cases, priority, schedules, operational states, etc. Each set of software may also communicate information such as coexistence state, policy, etc. to its respective firmware. The firmware may use such information to control the radio hardware in implementing coexistence policies. Communication between a UWB radio (e.g., the UWB Logic 332) and a Wi-Fi radio (e.g., the WLAN/PAN Logic 336) may be implemented in any of various ways, depending on the hardware and software used. For example, in some implementations each of the radios may pass information to the processor(s) 302, which may relay relevant information to the other radio. As another example, some implementations may include one or more general purpose input/output (GPIO) connections, system power management interfaces (SPMI), custom interfaces and/or other interfaces between the UWB radio, the NB radio, the cellular radio, and the Wi-Fi radio, to allow direct real-time communication.

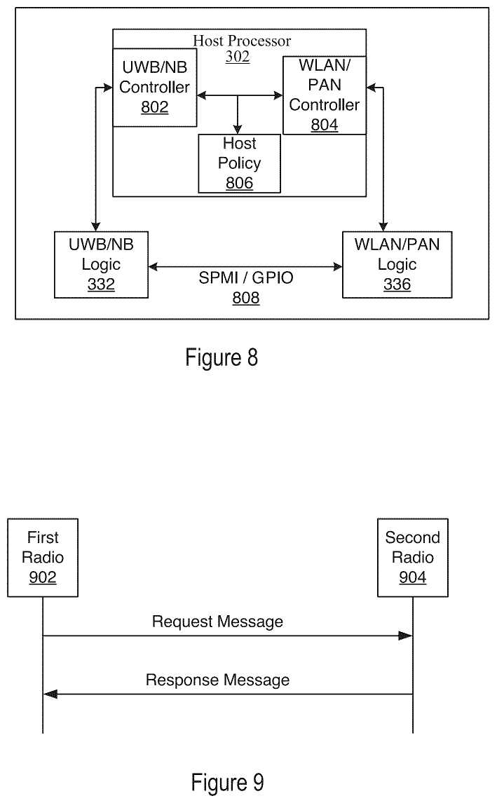

### FIG. 8—Host Processor and Host Policy for Radio Coexistence

FIG. 8 provides another example illustration. In this example, a host processor, such as processor 302, can be in communication with a UWB/NB radio controller 802 and a WLAN/PAN controller 804. The UWB/NB controller can communicate a host policy 806 from the host processor 302 to the UWB/NB logic 332 to implement the coexistence state or policy at the hardware or firmware of a UWB radio or a NB radio. Similarly, the WLAN/PAN controller 804 can communicate the host policy 806 to the WLAN/PAN logic 336 to implement the coexistence state or policy at the hardware or firmware of a WLAN/PAN radio, such as a Wi-Fi radio or a Bluetooth radio, or another type of wireless LAN or PAN radio. The host policy can be set by the software operating on the wireless device, such as wireless device 110, that uses the wireless communication circuitry 330 illustrated in FIG. 3.

In one embodiment, the UWB radio and the NB radio can be implemented on a single chip or circuit. Similarly, the Bluetooth radio and Wi-Fi radio can be implemented on a single chip or circuit. A communication path, such as an SPMI or GPIO 808 that can be used to enable the UWB/NB logic 332 to communicate with the WLAN/PAN logic 336. Alternatively, a General-Purpose Input Output (GPIO) can also be used to enable the UWB/NB logic 332 to communicate with the WLAN/PAN logic 336. While the circuitry/radios are illustrated as being combined in FIGS. 3 and 8, this is not intended to be limiting. In another embodiment, each of the UWB radio, NB radio, Cellular radio, Wi-Fi radio, Bluetooth radio may be implemented as separate logic on separate circuits or chips and configured to communicate using an SPMI connection and/or GPIO connection.

In one embodiment, a Controller on a radio can also use a cloud connection to coordinate the parameters of the remote device that the radio is attempting to range to for its local radios. In this way a good overall channel can be found for a link between the radios, thereby avoiding impacts for some of the radios as a result.

In one embodiment, the host policy 806 can be configured to have awareness of active applications that are using a Wi-Fi radio. In situations where the Wi-Fi radio can tolerate a higher duty cycle of activity by the UWB radio, with minimal disruptions to the Wi-Fi radio or the active applications, this can be permitted by the host policy. The higher duty cycle of activity by the UWB radio is used to ensure that the UWB radio's latency can be optimized in favor of the UWB radio when the Wi-Fi radio and other victim radios (i.e. BT or cellular) are not performing activities that are severely impacted by the UWB features.

### FIG. 9—Request and Response Message Communication

FIG. 9 illustrates an example embodiment in which a request message is communicated from a first radio 902 to a second radio 904. The first radio 902 can then receive a response message from the second radio 904. In one example, the first radio 902 can be a NB radio. The NB radio can be implemented as the UWB/NB logic 332, as illustrated in FIG. 3. The second radio 904 can be a Wi-Fi radio. The Wi-Fi radio can be implemented as the WLAN/PAN logic 336, as illustrated in FIG. 3. The NB radio may be configured to communicate in the UNII-3 band illustrated in FIG. 4. The Wi-Fi radio may be configured to operate in multiple bands, including the Wi-Fi 2.4 GHz band, presented in Table 1, the Wi-Fi 5 GHz band, presented in Table 2, or the Wi-Fi 6 GHz band, presented in Table 3. While these bands are illustrated as examples, they are not intended to be limiting. Other bands are also included in the Wi-Fi 6e specification. In addition, new bands or channels are often added in the Wi-Fi specification. The illustrated bands in Tables 1-3 are shown to demonstrate examples of various coexistence schemes as the NB radio, UWB radio and Wi-Fi radio operate. Moreover, the first radio 902 and the second radio 904 can be any radio within a wireless device, such as wireless device 110. For instance, the first radio 902 or the second radio 904 can be a cellular radio, a BT radio, an NB radio, a Wi-Fi radio, a UWB radio, or another desired radio.

TABLE 1
Wi-Fi 2.4 GHz Band

| | | DSSS | OFDM |
|---|---|---|---|
| | F₀ | Frequency Range | Frequency Range |
| Channel # | MHz | (Mhz) | (Mhz) |
| 1 | 2412 | 2401-2423 | 2402-2422 |
| 2 | 2417 | 2406-2428 | 2407-2427 |
| 3 | 2422 | 2411-2433 | 2412-2432 |
| 4 | 2427 | 2416-2438 | 2417-2437 |
| 5 | 2432 | 2421-2443 | 2422-2442 |
| 6 | 2437 | 2426-2448 | 2427-2447 |
| 7 | 2442 | 2431-2453 | 2432-2452 |
| 8 | 2447 | 2436-2458 | 2437-2457 |
| 9 | 2452 | 2441-2463 | 2442-2462 |
| 10 | 2457 | 2446-2468 | 2447-2467 |
| 11 | 2462 | 2451-2473 | 2452-2472 |
| 12 | 2467 | 2456-2478 | 2457-2477 |
| 13 | 2472 | 2461-2483 | 2462-2482 |
| 14 | 2484 | 2473-2495 | |

TABLE 2
Wi-Fi 5 GHz Band

| | | Range | U-NII |
|---|---|---|---|
| Channel # | (MHz) | (MHz) | band(s) |
| 32 | 5160 | 5150-5170 | U-NII-1 |
| 36 | 5180 | 5170-5190 | |
| 40 | 5200 | 5190-5210 | |
| 44 | 5220 | 5210-5230 | |
| 48 | 5240 | 5230-5250 | |
| 52 | 5260 | 5250-5270 | U-NII-2A |
| 56 | 5280 | 5270-5290 | |
| 60 | 5300 | 5290-5310 | |
| 64 | 5320 | 5310-5330 | |
| 68 | 5340 | 5330-5350 | |
| 72 | 5360 | 5350-5370 | U-NII-2B |
| 76 | 5380 | 5370-5390 | |
| 80 | 5400 | 5390-5410 | |
| 84 | 5420 | 5410-5430 | |
| 88 | 5440 | 5430-5450 | |
| 92 | 5460 | 5450-5470 | |
| 96 | 5480 | 5470-5490 | U-NII-2C |
| 100 | 5500 | 5490-5510 | |
| 104 | 5520 | 5510-5530 | |
| 108 | 5540 | 5530-5550 | |
| 112 | 5560 | 5550-5570 | |
| 116 | 5580 | 5570-5590 | |
| 120 | 5600 | 5590-5610 | |
| 124 | 5620 | 5610-5630 | |
| 128 | 5640 | 5630-5650 | |
| 132 | 5660 | 5650-5670 | |
| 136 | 5680 | 5670-5690 | |
| 140 | 5700 | 5690-5710 | |
| 144 | 5720 | 5710-5730 | U-NII-2C/3 |
| | | 5730-5735 | U-NII-3 |
| 149 | 5745 | 5735-5755 | |
| 153 | 5765 | 5755-5775 | |
| 157 | 5785 | 5775-5795 | |
| 161 | 5805 | 5795-5815 | |
| 165 | 5825 | 5815-5835 | |
| 169 | 5845 | 5835-5855 | U-NII-3/4 |
| 173 | 5865 | 5855-5875 | U-NII-4 |
| 177 | 5885 | 5875-5895 | |

TABLE 3
Wi-Fi 6 GHz Band

| Ch. | F₀ | Range | U-NII |
|---|---|---|---|
| 20 MHz | MHz | (MHz) | band(s) |
| 2 | 5935 | 5925-5945 | U-NII-5 |
| 1 | 5955 | 5945-5965 | |
| 5 | 5975 | 5965-5985 | |
| 9 | 5995 | 5985-6005 | |
| 13 | 6015 | 6005-6025 | |
| 17 | 6035 | 6025-6045 | |
| 21 | 6055 | 6045-6065 | |
| 25 | 6075 | 6065-6085 | |
| 29 | 6095 | 6085-6105 | |
| 33 | 6115 | 6105-6125 | |
| 37 | 6135 | 6125-6145 | |
| 41 | 6155 | 6145-6165 | |
| 45 | 6175 | 6165-6185 | |
| 49 | 6195 | 6185-6205 | |
| 53 | 6215 | 6205-6225 | |
| 57 | 6235 | 6225-6245 | |
| 61 | 6255 | 6245-6265 | |
| 65 | 6275 | 6265-6285 | |
| 69 | 6295 | 6285-6305 | |
| 73 | 6315 | 6305-6325 | |
| 77 | 6335 | 6325-6345 | |
| 81 | 6355 | 6345-6365 | |
| 85 | 6375 | 6365-6385 | |
| 89 | 6395 | 6385-6405 | |
| 93 | 6415 | 6405-6425 | |
| 97 | 6435 | 6425-6445 | U-NII-6 |
| 101 | 6455 | 6445-6465 | |
| 105 | 6475 | 6465-6485 | |
| 109 | 6495 | 6485-6505 | |
| 113 | 6515 | 6505-6525 | |
| 117 | 6535 | 6525-6545 | U-NII-7 |
| 121 | 6555 | 6545-6565 | |
| 125 | 6575 | 6565-6585 | |
| 129 | 6595 | 6585-6605 | |
| 133 | 6615 | 6605-6625 | |
| 137 | 6635 | 6625-6645 | |
| 141 | 6655 | 6645-6665 | |
| 145 | 6675 | 6665-6685 | |
| 149 | 6695 | 6685-6705 | |
| 153 | 6715 | 6705-6725 | |
| 157 | 6735 | 6725-6745 | |
| 161 | 6755 | 6745-6765 | |
| 165 | 6775 | 6765-6785 | |
| 169 | 6795 | 6785-6805 | |
| 173 | 6815 | 6805-6825 | |
| 177 | 6835 | 6825-6845 | |
| 181 | 6855 | 6845-6865 | |
| 185 | 6875 | 6865-6885 | U-NII-7/8 |
| 189 | 6895 | 6885-6905 | U-NII-8 |
| 193 | 6915 | 6905-6925 | |
| 197 | 6935 | 6925-6945 | |
| 201 | 6955 | 6945-6965 | |
| 205 | 6975 | 6965-6985 | |
| 209 | 6995 | 6985-7005 | |
| 213 | 7015 | 7005-7025 | |
| 217 | 7035 | 7025-7045 | |
| 221 | 7055 | 7045-7065 | |
| 225 | 7075 | 7065-7085 | |
| 229 | 7095 | 7085-7105 | |
| 233 | 7115 | 7105-7125 | |

As shown in Table 2, the Wi-Fi 5 GHz band includes the U-NII band 3, including channels 149, 153, 157, 161 and 165. This is the same band and channels that can be used by the NB radio, in one example embodiment. In addition, the channels in the Wi-Fi 6 GHz band, illustrated in Table 3, occur in the same frequency bands as UWB channels 5, 6 and 7, as shown in FIGS. 7a and 7b. The upper channels, such as the Wi-Fi channels in U-NII bands 7 and 8, can also cause potential interference with communication by the UWB radio in UWB channels 8, 9 and 11.

In one embodiment, the use of the NB radio within the same bands as the Wi-Fi 5 GHz band (see Table 2), can significantly enhance the range of the UWB/NB radios due to the higher transmission power of the NB radio in the Wi-Fi 5 GHz band compared with the transmission power of BLE in the 2.4 GHz band. However, aggressive use of the NB radio for scanning and advertisement, as illustrated in the example of FIG. 5, to enable the long range, can have substantial impact on the ability of other radios to transmit and receive.

The transmission and reception of the NB radio with other devices (i.e. wireless device 180) has been designed to limit the impacts of the NB radio on other radios. In accordance with one embodiment, the NB radio's transmissions used for advertisement by the initiator were designed to be limited in duration, such as around 500 to 600 microseconds in length. The period for the poll (transmission) and response (reception) can be spaced apart by approximately 1500 microseconds. The short transmissions and spacing of the transmission and reception can reduce the interference that may be caused on other radios, such as the Wi-Fi radio, due to the transmissions of the wireless devices (i.e. 110 and 180).

In addition, the UWB transmissions by the UWB radio can have a duration of X microseconds. The duration of the transmission can be sufficiently short (i.e. less than 100 microseconds) to permit concurrency in transmission with other radios. The UWB fragments transmitted in in the MMS slot 612, as illustrated in one embodiment in the example of FIG. 6, can have the transmission and reception (Tx and Rx) periods interleaved. By interleaving the Tx and Rx response, the duration for the impacted radios is minimized. This can minimize the duration of the disruption to low latency applications using other radios, such as a Wi-Fi radio. In one example, the interleaved fragments in the MMS slot 612 are configured to minimize a time duration of the UWB radio activity in UWB channel 9. The fragments can be sufficiently short, relative to a highest modulation and coding scheme (MCS) used by a Wi-Fi radio to transmit and receive data packets, that concurrency between the UWB radio and the Wi-Fi radio, such downlink Wi-Fi concurrency, can continue with some contained impact. The combination of the NB radio in use with the UWB radio, as illustrated in FIGS. 5 and 6, can exploit the advantages of each. By splitting up the function across two radios, it minimizes the impact to other radios, as only limited Wi-Fi bands, in one example, are impacted by use of both radios concurrently.

In accordance with one embodiment, in order to limit the interference during transmissions and reception by the radios of the UWB/NB logic 332, cellular logic 334, and WLAN/PAN logic 336, specific information can be shared between two or more radios as illustrated in the example of FIG. 9. New coexistence methodologies can be used to enhance the capabilities of multiple active radios in a wireless device 110 to enable the multiple radios to perform with low latency and high throughput when communicating with other wireless devices, such as those illustrated in the example of FIG. 1.

Prior to the use of the NB radio in the Wi-Fi 5 GHz range, the cellular, Wi-Fi, BT, and UWB radios used preliminary coexistence functions using a general purpose Input/Output (GPIO) interface. While it provides preliminary coexistence functions, it was far from ideal as it has severe limitations to exchange information among the radios.

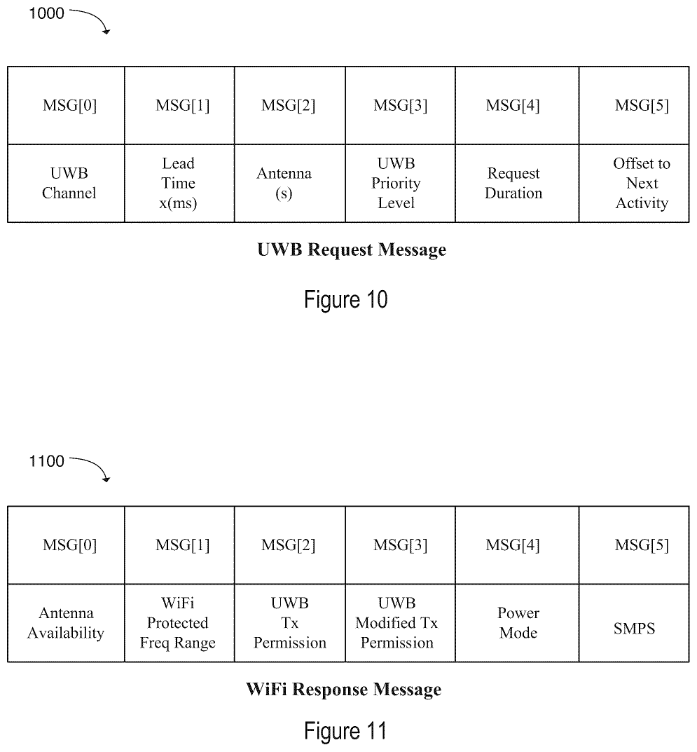

### FIGS. 10 and 11—Radio Request and Response Messages

FIG. 10 illustrates an example request message 1000 communicated from a first radio to a second radio. In this example, the first radio 902 illustrated in FIG. 9 can be a UWB radio. The second radio 904 can be a Wi-Fi radio. In one alternative, the UWB radio can be a combined UWB/NB radio and the request message 1000 and response message 1100 (FIG. 11) can be used to schedule both the NB radio, the UWB radio, and the Wi-Fi radio. In the example request message 1000 illustrated in FIG. 10, selected information can be communicated from the UWB radio to the Wi-Fi radio using a communication path, such as SPMI.

In the example of FIG. 10, the request message 1000 can include a UWB channel that is used by the UWB radio. Example UWB channels can be UWB Channel 5 or UWB Channel 9 (see FIGS. 7a and 7b), although other channels may also be selected. UWB Channel 9 is further outside of the Wi-Fi 6 GHz band. This can provide simpler coexistence than using UWB channel 5, which operates in approximately the same RF band as Wi-Fi 6 GHz channels 61 to 161.

Coexistence functions can be expanded to cover the new use cases of the UWB radio, such as those illustrated in the examples of FIGS. 5 and 6, through a greater use of the SPMI General Purpose Radio 0 (GPR0) mechanisms. Real-time radio disruptions can be indicated by GPR0. The disruptions can be identified uniquely for events per the UWB channel designated in the request message 1000. The indications of the real-time disruptions can allow the Wi-Fi radio better visibility on how to respond to activity by the UWB radio and permit concurrency for the RF bands that are unimpacted. This extra information can also permit Wi-Fi limited concurrency even when operating in conflicting bands. For example, when using UWB channel 5, a Wi-Fi radio can provide limited concurrency by being configured to operate in channels that are less likely to be affected by the UWB channel 5 transmission, such as using the Wi-Fi 2.4 GHz band, or selecting channels in the UNII-1 to UNII-2c bands. Similarly, when using UWB channel 9, a Wi-Fi radio can be configured to operate in the lower UNII bands 1-5. The bands that are selected for operation can be selected for a specific implementation.

In one example, the SPMI can be used for the UWB radio to request, to the Wi-Fi radio, access to one or more antennas used by the Wi-Fi radio, with a limited lead time, such as x milliseconds, where x is a positive integer. The request message 1000 can also include a priority indication and a duration of the request, which can be used by the Wi-Fi radio to determine mitigation efforts.

In one example, a priority indication for a radio can be selected for a given use case so that the behavior of the coexistence between the first radio 902 and the second radio 904 can be identified by design. The use case can be a specific software program, a portion of a software program, or a portion of a communication. In one example, the host processor 302, as illustrated in FIGS. 3 and 8, can expand the situations in which one radio, such as a Wi-Fi radio, is permitted to use a higher priority to preserve the most critical activities. A host policy 806 can permit a selected radio, such as the Wi-Fi radio, to monitor the rate at which the Wi-Fi radio allows the activity of one or more other radios, such as a UWB radio. The rate can be determined for upcoming activities in the lead time period.

The rate at which the activity is allowed can be compared with the rate at which a request (i.e. a UWB request message 1000) is rejected. A request made by the first radio 902 may be rejected, for example, when there is a conflict with a frequency range during the request duration, the use of antennas by the second radio during the request duration, or a priority level of the Wi-Fi radio, in this example, is greater than the priority of the UWB radio's upcoming transmission. The first radio 902 can use the rejection information from the second radio 904 to reschedule its activities to factor in the conflict information in the rejection.

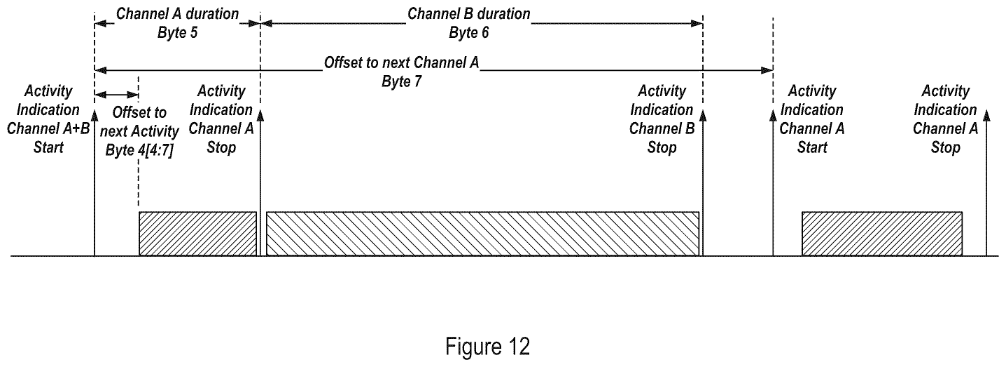

The request message 1000 can include an offset time until a next activity. An activity can be a period of time over which the UWB radio or NB radio may transmit or receive within a channel. For example, the activity may be a transmission window or a reception window for an expected transmission or reception, such as the transmission and reception of UWB fragments in the MMS slot 612 during the MMS slot period 610. Alternatively, the activity may be both a transmission period and a reception period. In one example, the activity window can be kept as small as possible to accommodate a selected transmission or reception. By keeping the activity window about the same size as an expected transmission or reception, it allows the radios more time to interoperate during periods when the other radios are not actively transmitting or receiving. This will be discussed more fully with respect to FIG. 12.

The details included in the request message 1000 illustrated in FIG. 10 permit the Wi-Fi radio, in this example, to assess potential impacts and respond. The Wi-Fi radio can use the priority information to understand the relative importance of the Wi-Fi radio's activities relative to that of the UWB radio.

FIG. 11 includes an example response message 1100. In this example, the Wi-Fi radio is responding to a request message 1000 from the UWB radio. This is not intended to be limiting. The first radio 902 and second radio 904 may be any radio operating within the wireless device 110. In the example of FIG. 11, the response message 1100 can include information including the availability of the antennas requested in the request message 1000. The response message 1100 may also include the availability of any or all antennas used by the first radio 902 and/or the second radio 904, not just the antennas in the request message 1000.

The response message 1100 can also include a frequency range that is protected by the second radio 904, such as the Wi-Fi radio in the example of FIG. 11. The frequency range may be protected to enable the second radio 904 to transmit data that has a higher priority than the priority level of the first radio 902 included in the request message 1000. This will be discussed more fully in the proceeding paragraphs.

The response message 1100 can include a transmit permission message. In this example, the transmit permission message can be a message informing the UWB radio that it has permission to transmit for the request duration at the lead time of x milliseconds on the UWB channel using the antennas, as designated in the request message 1000.

The response message 1100 can also include a modified transmit permission message. In this example, the modified transmit permission message can include an alternative to the information included in the request message 1000. For example, the modified Tx permission message may include a different channel for the first radio (i.e. UWB radio) to transmit on, a different lead time for the transmission to start on, different antennas for the transmission of the UWB radio to use, and/or a different duration for the transmission. If the information is acceptable to the first radio, the first radio can proceed with the transmission as detailed in the modified Tx permission sent in the response message 1100.

The response message 1100 can also result in power saving of the link being used by the Wi-Fi radio to permit activity by another radio, such as the UWB radio, while still meeting SAR requirements. The SPMI messaging permits the second radio (e.g. Wi-Fi radio) to initiate protection mechanisms such as the power saving mode to preserve a second radio data link from dips in throughput due to disruptions by the first radio (e.g. UWB radio).

FIG. 12—Activity Timing Diagram with Offset Time Period to Next Activity

FIG. 12 provides an example illustrating an activity timing diagram 1200 for the first radio 902. The activity timing diagram 1200 provides the timing of the activities for each channel that the activities are communicated on. In the example of FIG. 12, there are activities that occur on channel A and channel B. For each channel, there is an activity indication start time. This time can be used to provide the lead time indication in the request message 1000. An activity indication stop time can for each channel can enable the duration of the activity for each channel to be calculated and included in the request message 1000.

In addition, when the next activity of the first radio 902 is known, the activity timing diagram 1200 can include an offset time period to the next activity for one or more of the channels. This offset period offers flexibility to inform the second radio 904 well ahead of time of upcoming activity. This can permit the second radio 904 time to take preventative measures to accommodate the requested transmission by the first radio. For example, when the second radio is a Wi-Fi radio, the offset time period until the next activity for a selected channel can provide time for the Wi-Fi radio to communicate with its access point to enable communication to continue, potentially on a different frequency band or channel. This can enable the second radio to provide a transmit permission in the response message 1100, as previously discussed. Without sufficient time for the Wi-Fi radio to communicate with the access point, it may not be possible for the Wi-Fi radio to provide the Tx permission to the first radio. The offset period also minimized the amount that the first radio (e.g. a UWB radio) needs to communicate request messages with long lead times to the second radio (e.g. the Wi-Fi radio) of upcoming transmissions. Accordingly, the offset to next activity time period can be communicated in the request message 1000, as illustrated in FIG. 10.

One challenge of radio coexistence schemes can occur when one of the wireless devices 110 fails to successfully communicate with another wireless device 150. For example, the first radio (e.g. UWB radio) of wireless device 110 may fail to decode a UWB transmission from wireless device 150. This can set the coexistence scheme into an unknown realm. To limit this, if the first radio fails to decode at some step, preventing the next activity of the first radio, then this can be signaled to the second radio as port of the stop message illustrated in FIG. 12. This will permit the second radio 904 in wireless device 110 to ignore earlier communications about upcoming wireless activities (e.g. UWB transmissions that may not occur). The second radio 904 can still respond in real time to new messages that may arise even if there were no earlier notifications that these messages were expected. The intent of the request message 1000 is a best effort to provide the flexibility for the second radio (e.g. Wi-Fi radio) to react if possible.

The information included in the request message 1000 from the first radio 902 to the second radio 904, and the information in the response message 1100 from the second radio to the first radio can provide an effective coexistence scheme that enables the first radio 902 and the second radio 904 to communicate with low latency and high throughput. While the request message 1000 and response message 1100 are illustrated as a group of serial messages organized for communication between the first and second radios 902, 904, this is not intended to be limiting. The individual messages included in the request message 1000 and the response message 1100 may be communicated separately or in combination with the other messages.

Wi-Fi/UWB GPIO Solution for Wireless Devices with Small Form Factor

In another example embodiment, a wireless device 110 can be configured to communicate with another wireless device, such as a wearable, a watch, a home product, a tag, or another wireless device with a small form factor. The wireless device with the small form factor, such as the watch 150, can have an increased scan duty cycle, L/T, as previously discussed with respect to FIG. 5. For instance, the transmit/receive period L can range from 20 to 100 microseconds, and the scan interval T can be repeated over a time period that can range from 100 microseconds to 1000 microseconds. In one example, L can be 40 and T can be 250, resulting in a duty cycle of sixteen percent. This higher duty cycle can result in puncturing of a Wi-Fi radio frame. This has limited the concurrent use of UWB radio communication in UWB channel 9 and Wi-Fi radio communication in Wi-Fi 5 GHz bands in small form factor wireless devices, due to the small filters used in the devices that may not be capable of providing sufficient filtering to allow the concurrent use of the UWB radio in channel 9 and the Wi-Fi radio in 5 GHz band. To overcome the limitation, a time division duplexing (TDD) operation was achieved using two GPIO, a UWB_radio_active and a Wi-Fi_Critical. The UWB_radio_active GPIO is used to take a front end switch away from Wi-Fi. However, the UWB_radio_active GPIO is configured to yield within a certain period, such as within 100 to 400 microseconds when the Wi-Fi_Critical GPIO is sensed, and remain inactive until the Wi-Fi_Critical GPIO is lowered.

In another embodiment, one additional GPIO can be added from the UWB radio to the Wi-Fi radio indicating UWB channel 9 (UWB_ch9). When UWB_ch9 and UWB_radio_active are both high, the Wi-Fi 5 radio can turn off transmissions in the 5 GHz band (mute 5 GHz Tx). When UWB_ch9 is low and UWB_radio_active is high, the Wi-Fi radio can turn off transmission in the 5 GHz band (mute 5 GHz Tx) and switch the shared front end away from Wi-Fi. Accordingly, reception of the 5 GHz band at the Wi-Fi radio will also be disrupted during this period as well. This allows the Wi-Fi radio to receive in the Wi-Fi 5 GHz band while the UWB radio transmits or receives in UWB channel 9. However, when the Wi-Fi radio transmits in the 5 GHz band, it can impact the UWB radio's ability to receive in the MMS slot 612 (FIG. 6). This enables full reception by the Wi-Fi radio in the 5 GHz band, with opportunistic transmission capability. By adding the UWB_ch9 GPIO, most Wi-Fi degradation due to UWB transmission and reception in the MMS slot 612 can be eliminated, since a Wi-Fi acknowledgement has a high chance of being successfully transmitted, as long as it is not colliding with the MMS UWB Rx window every millisecond, during the MMS slot 612.

### Wi-Fi P2P Protection

Peer to Peer (P2P) applications often use the higher frequency bands in the Wi-Fi standard, such as the 5 GHz band historically, and the new 5 GHz band more recently. The higher bands can provide greater bandwidth than the 2.4 GHz band, and are often less crowded. P2P applications are often designed to take full advantage of the newest capabilities of a wireless device and the updates in the Wi-Fi standard. This can result in connections, such as Wi-Fi P2P connections, that can have high demands on the wireless device and the connection timing, including needs for high bandwidth and low latency. Interference between multiple radios, such as a UWB radio, an NB radio, and a Wi-Fi radio can result in increased latency and audio/video jitters for applications such as YouTube that are not acceptable.

For example, Apple Wireless Direct Link (AWDL) is a low latency, high speed Wi-Fi P2P connection that Apple uses for P2P connections, such as GameKit, AirPlay, AirDrop, and so forth. AWDL has a critical time window, called Available Window (AW), for 16 milliseconds out of 64 milliseconds (25%) that needs to be protected from interference with other radios. Other brands of wireless devices use a similar protocol called Neighbor Awareness Networking (NAN) that has a critical Discovery Window (DW) that is protected for 16 ms out of 512 ms (3.125%). The protection of these time windows can be built in to the application by default by prioritizing the Wi-Fi radio during the critical windows and de-prioritizing, or even denying, other radios operating within the Wi-Fi 2.4 GHz, 5 GHz, and 6 GHz bands.

With the NB radio used to transmit at higher power, the impact of the NB radio to the Wi-Fi radio is typically in the Wi-Fi 5 GHz and 6 GHz bands as the NB radio is used in the UNII band 3 from 5.725 GHz to 5.850 GHz. In addition, when UWB is used in selected channels, such as Channel 9, it can affect the Wi-Fi radio in the upper channels of the 6 GHz band. Accordingly, the host policy 806 can be configured to provide protection schemes for the Wi-Fi 2.4 GHz, 5 GHz, and 6 GHz bands independently. The protection of P2P connections, such as the AW and DW windows for AWDL and NAN, can be included in the host policy 806, by providing the Wi-Fi bands with a higher prioritization than the UWB radio during the critical periods, and/or denying the use of selected bands to other radios, such as the UWB and NB radios, during the critical windows. This information can be sent down from the host policy 806 to the software and firmware in the UWB/NB logic 332 and the WLAN/PAN logic 336.

### Wi-Fi 5 GHz Band and Bluetooth Low Energy 2.4 GHz TDD Solution

As previously discussed, Bluetooth (BT) transmissions in the 2.4 GHz band are power limited due to SAR limitations, since the band is simultaneously used with Wi-Fi radio operations in the 5 GHz and 6 GHz bands. In order to improve the BT transmit power, the BT transmissions in the 2.4 GHz band can have time sharing (TDD) with the Wi-Fi radio transmissions in the Wi-Fi 5 GHz and 6 GHz bands. Since these are SAR limitations, there are no limitations on the concurrent reception by the BT radio and the Wi-Fi radio. Accordingly, TDD is only limited to concurrent transmission (Tx/TX) by both of the BT and Wi-Fi RATs. The other combinations of Tx/Rx, Rx/Tx, and Rx/Rx can be performed concurrently. In one embodiment, the BT radio can perform TDD with the Wi-Fi radio in the 5 GHz and 6 GHz bands, as long as the BT radio is used for UWB acquisition, as illustrated in FIGS. 5 and 6. When using TDD for the BT radio, the output power of the BT radio can be significantly increased by using an external power amplifier (ePA).

In one example, when an application that uses UWB on a wireless device 110 is active, the application can send a tag to BT host software. An application that uses UWB can include a “find my” type of application that enables a device that is remote to the wireless device 110 to found, such as another wireless device 150, a watch 180, earbuds 120, a tag 130, a third-party accessory 170, and so forth. The application that uses UWB may also be an application that provides a nearby interaction with other devices or an audio handoff, as discussed with respect to FIG. 1.

The application may be considered active when a user is actively using it and/or it is displayed on the screen of the wireless device 110. Alternatively, the application may also be considered active when it is operating in the background on the wireless device. The BT radio (i.e. WLAN/PAN Logic 336) can request Bluetooth low energy (BLE) advertising to be performed with a UWB tag, which can be sent to the Bluetooth firmware. When the Bluetooth firmware sends a Bluetooth request to a Wi-Fi radio, the Wi-Fi radio can perform Tx/Tx TDD communication in the Wi-Fi 5 GHz and 6 GHz bands with the Bluetooth radio to enable the higher power transmissions for UWB acquisition using an ePA with the Bluetooth radio.

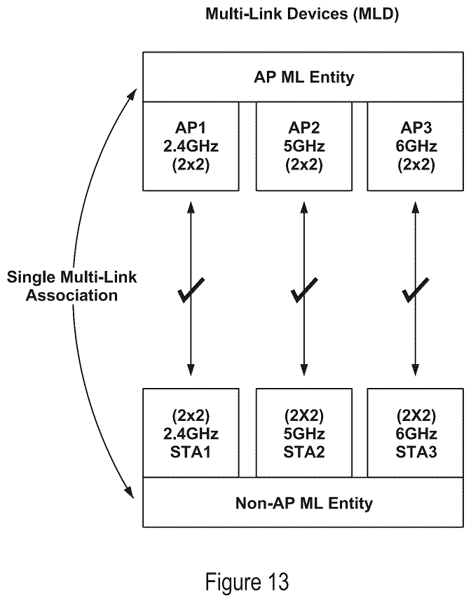

### FIG. 13—Wi-Fi 7 and UWB Coexistence: Multi-Link Operation

Wi-Fi 7 is an upcoming specification for the Wi-Fi standard that has not been finalized and released yet. Wi-Fi 7 is expected to support simultaneous transmission and reception on multiple links for data traffic to a single access point (AP), as illustrated in the example of FIG. 13. The Wi-Fi radio will support dynamically switching transmit and receive among different links to avoid congested links. In one embodiment, when a UWB radio is operating in a wireless device 110, the UWB radio can send an upcoming traffic pattern to the Wi-Fi radio via a link, such as an SPMI. The Wi-Fi radio can then schedule the traffic based on the UWB traffic pattern, BT status, Wi-Fi link quality and the radio environment, such as the noise floor. In FIG. 13, a non-access point multi-link entity, such as a UE configured as a cellular phone, can communicate with separate links connected in the Wi-Fi 2.4 GHz band, the Wi-Fi 5 GHz band, and the Wi-Fi 6 GHz band. Transmissions or reception at the UE with the multi-link access point can be moved between the different transmit and receive connections. This can enable the Wi-Fi radio to be used concurrently with other radios, such as the BT radio and the UWB radio.

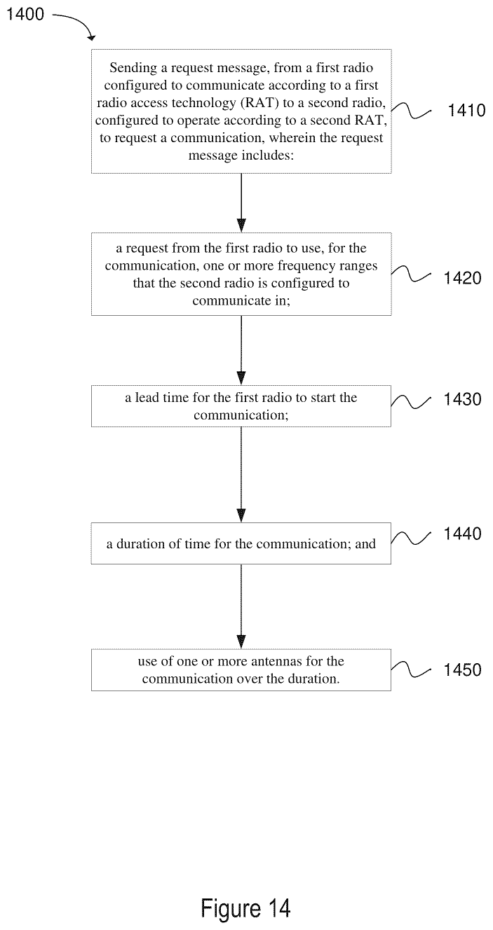

### FIG. 14—Method

FIG. 14 illustrates a block diagram of an example of a method 1400 for operating two or more radios in a User Equipment (UE) having different radio access technologies (RATs), according to some embodiments. The method 1400 shown in FIG. 14 may be used in conjunction with any of the systems, methods, or devices shown in the Figures, among other devices. In various embodiments, some of the method elements shown may be performed concurrently, in a different order than shown, or may be omitted. Additional method elements may also be performed as desired. As shown, this method may operate as follows.

At 1410, a wireless device, such as mobile device 110, operating two or more radios having different radio access technologies (RATs) can send a request message, from a first radio configured to communicate according to a first RAT, to a second radio, configured to communicate according to a second RAT, to request a communication.

The request message can comprise a request 1420 from the first radio to use, for the communication, one or more frequency ranges that the second radio is configured to communicate in. The request message can include 1430 a lead time for the first radio to start the communication. The request message can further include a duration 1440 of time for the communication. The request message can further include use of one or more antennas 1450 for the communication over the duration.

In one example, the one or more frequency ranges can comprise a Wi-Fi 2.4 Gigahertz (GHz) band designated by Institute of Electronics and Electrical Engineers (IEEE) in an 802.11ax specification (September 2020); or a Wi-Fi 5 GHz band designated by the IEEE in the 802.11ax specification; or a Wi-Fi 6 GHz band designated by the IEEE in the 802.11ax specification; or an ultra-wideband (UWB) channels 5 to 15 designated by the IEEE in an IEEE 802.15.4z-2020 (June 2020) specification; or a Bluetooth band from 2.4 GHz to 2.4835 GHz comprising channels 0 to 79 designated by a Bluetooth 5.4 (February 2023) specification; or a 3GPP third-generation partnership project (3GPP) Evolved Universal Terrestrial Radio Access (E-UTRA) operating bands 1 to 88 designated by a 3GPP TS 36.104 V. 18.2.0 (June 2023) specification; or 3GPP new radio (NR) operating bands n1 to n99 and n257 to n262 designated by a 3GPP TS 38.104 V. 18.2.0 (June 2023) specification; or a narrowband (NB) operating band within the Wi-Fi 5 GHz band or the Wi-Fi 6 GHz band.

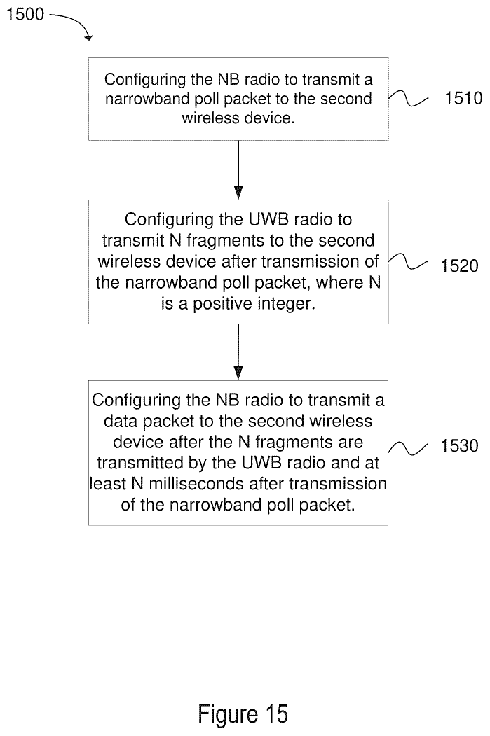

### FIG. 15—Method

FIG. 15 illustrates a block diagram of an example of a method 1500 for ranging from a first wireless device having multiple radios to a second wireless device, according to some embodiments. The method 1500 shown in FIG. 15 may be used in conjunction with any of the systems, methods, or devices shown in the Figures, among other devices. In various embodiments, some of the method elements shown may be performed concurrently, in a different order than shown, or may be omitted. Additional method elements may also be performed as desired. As shown, this method may operate as follows.

In some embodiments, the first wireless device can comprise an ultra-wideband (UWB) radio configured to communicate according to a UWB radio access technology (RAT); a wireless local area network (WLAN) radio configured to communicate according to a Wi-Fi RAT; and a narrowband (NB) radio.

The method 1500 comprises configuring the NB radio to transmit a narrowband poll packet to the second wireless device, as shown in block 1510. The UWB radio is configured to transmit N fragments to the second wireless device after transmission of the narrowband poll packet, where N is a positive integer, as shown in block 1520. The NB radio is configured to transmit a data packet to the second wireless device after the N fragments are transmitted by the UWB radio and at least N milliseconds after transmission of the narrowband poll packet, as shown in block 1530.

In some embodiments, the method 1500 further comprises enabling real-time communication between the UWB radio, the WLAN radio, and the NB radio with a system power management interface (SPMI).

In some embodiments, the method 1500 further comprises configuring the UWB radio to receive N fragments from the second wireless device, wherein the N received fragments are interleaved with the N transmitted fragments to minimize a duration of a disruption to the WLAN radio during the transmission of the N transmitted fragments and the reception of the N interleaved received fragments by the UWB radio. In some embodiments, the N received fragments and the N transmitted fragments are interleaved for communication in a multi-millisecond (MMS) slot.

In some embodiments, the method 1500 further comprises configuring the WLAN radio to receive a Wi-Fi downlink signal from a Wi-Fi access point concurrent with the UWB radio receiving the N fragments from the second wireless device.

In some embodiments, one of the N fragments has a transmission duration of the UWB radio of less than 100 microseconds. An NB poll packet can have a transmission duration of the NB radio of less than 1000 microseconds. The NP radio is configured to receive a NB response packet from the second wireless device after the transmission of the NB poll packet. The NB radio can also be configured to receive a data packet from the second wireless device after the transmission of the data packet from the NB radio.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Embodiments of the present disclosure may be realized in any of various forms. For example, some embodiments may be realized as a computer-implemented method, a computer-readable memory medium, or a computer system. Other embodiments may be realized using one or more custom-designed hardware devices such as ASICs. Still other embodiments may be realized using one or more programmable hardware elements such as FPGAs.

In some embodiments, a non-transitory computer-readable memory medium may be configured so that it stores program instructions and/or data, where the program instructions, if executed by a computer system, cause the computer system to perform a method, e.g., any of the method embodiments described herein, or, any combination of the method embodiments described herein, or, any subset of any of the method embodiments described herein, or, any combination of such subsets.

In some embodiments, a device (e.g., a UE 106) may be configured to include a processor (or a set of processors) including one or more baseband processors and one or more application processors and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Any of the methods described herein for operating a user equipment (UE) may be the basis of a corresponding method for operating a base station, by interpreting each message/signal X received by the UE in the downlink as message/signal X transmitted by the base station, and each message/signal Y transmitted in the uplink by the UE as a message/signal Y received by the base station.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A wireless device comprising:
a first radio configured to communicate according to a first radio access technology (RAT);
a second radio configured to communicate according to a second RAT; and
at least one processor configured to cause the wireless device to:
send a request message, from the first radio to the second radio, to request a communication, wherein the request message comprises:
a request from the first radio to use, for the communication, one or more frequency ranges that the second radio is configured to communicate in;
a lead time for the first radio to start the communication;
a duration of time for the communication; and
use of one or more antennas for the communication over the duration.

2. The wireless device of claim 1, wherein the at least one processor is further configured to cause the wireless device to:
receive, by the first radio, a response message from the second radio, the response message comprising:
an availability of the one or more antennas for first radio over the duration; and
a communication permission or a communication denial for the first radio to communicate in the one or more frequency ranges for the duration.

3. The wireless device of claim 2, wherein the response message further comprises:
one or more frequency ranges that are protected by the second radio from use by the first radio during the duration.

4. The wireless device of claim 2, wherein the response message further comprises:
a modified permission message for the communication, comprising one or more of:
a different frequency range for the communication than the one or more frequency ranges in the request message;
a different lead time for the first radio to start the communication;
a different duration for the communication; or
a different antenna for the communication than the one or more antennas in the request message.

5. The wireless device of claim 4, wherein the at least one processor is further configured to cause the wireless device to:
communicate the request message from the first radio to the second radio using a system power and management interface (SPMI); and
communicate the response message from the second radio to the first radio using the SPMI.

6. The wireless device of claim 1, wherein the one or more frequency ranges comprises one or more frequency channels or one or more frequency bands.

7. The wireless device of claim 1, wherein the request message further indicates a first priority level.

8. The wireless device of claim 7, wherein the at least one processor is configured to cause the wireless device to:
determine that a communication by the second radio, in the one or more frequency ranges, is scheduled for at least a portion of the duration;
determine a second priority level associated with the communication by the second radio; and
permit the first radio to perform the communication when the first priority level is greater than the second priority level.

9. The wireless device of claim 1, wherein the request message further comprises at least one of:
an offset time to a next activity for the first radio to enable the second radio to accommodate a communication by the first radio at the next activity; or
a stop message comprising an indication of a decode failure by the first radio to enable the second radio to determine that pending communications by the first radio will not occur.

10. The wireless device of claim 1, wherein the first RAT is different from the second RAT and the first RAT and the second RAT are configured to communicate according to:
a Wi-Fi Institute of Electronics and Electrical Engineers (IEEE) 802.11 protocol; or
a third-generation partnership project (3GPP) new radio (NR) fifth generation (5G) standard; or
a Bluetooth standard; or
an ultra-wideband IEEE 802.15.4z-2020 standard; or
a narrowband standard.

11. The wireless device of claim 1, wherein the one or more frequency ranges are selected from:
a Wi-Fi 2.4 Gigahertz (GHz) band; or
a Wi-Fi 5 GHz band; or
a Wi-Fi 6 GHz band; or
ultra-wideband (UWB) channels 5 to 15; or
a Bluetooth band from 2.4 GHz to 2.4835 GHz comprising channels 0 to 79; or
third-generation partnership project (3GPP) Evolved Universal Terrestrial Radio Access (E-UTRA) operating bands 1 to 88; or
3GPP new radio (NR) operating bands n1 to n99 and n257 to n262; or
a narrowband (NB) operating band within the Wi-Fi 5 GHz band or the Wi-Fi 6 GHz band.

12. The wireless device of claim 2, wherein the at least one processor is further configured to:
cause the wireless device to send the request message for a selected use case for the first radio; or
cause the wireless device to send the response message for a selected use case for the second radio, wherein the selected use case comprises one or more of the use of a specific software program, a portion of a software program, or a portion of a communication.

13. The wireless device of claim 1, wherein:
the first radio is configured to communicate according to a narrowband (NB) radio access technology (RAT);
the second radio is configured to communicate according to a Wi-Fi RAT; and
the at least one processor is further configured to:
send an NB activation message to the second radio prior to a transmission by the first radio, the NB activation message indicating to the second radio to adjust a Specific Absorption Rate (SAR) budget to account for a transmission power of the NB radio.

14. A method for ranging from a first wireless device having multiple radios to a second wireless device, the first wireless device comprising:
an ultra-wideband (UWB) radio configured to communicate according to a UWB radio access technology (RAT);
a wireless local area network (WLAN) radio configured to communicate according to a Wi-Fi RAT; and
a narrowband (NB) radio;
the method comprising:
configuring the NB radio to transmit a narrowband poll packet to the second wireless device;
configuring the UWB radio to transmit N fragments to the second wireless device after transmission of the narrowband poll packet, where N is a positive integer; and
configuring the NB radio to transmit a data packet to the second wireless device after the N fragments are transmitted by the UWB radio and at least N milliseconds after transmission of the narrowband poll packet.

15. The method of claim 14, further comprising enabling real-time communication between the UWB radio, the WLAN radio, and the NB radio with a system power management interface (SPMI).

16. The method of claim 14, further comprising configuring the UWB radio to receive N fragments from the second wireless device, wherein the N received fragments are interleaved with the N transmitted fragments to minimize a duration of a disruption to the WLAN radio during the transmission of the N transmitted fragments and the reception of the N interleaved received fragments by the UWB radio.

17. The method of claim 16, wherein the N received fragments and the N transmitted fragments are interleaved for communication in a multi-millisecond (MMS) slot.

18. The method of claim 16, further comprising configuring the WLAN radio to receive a Wi-Fi downlink signal from a Wi-Fi access point concurrent with the UWB radio receiving the N fragments from the second wireless device.

19. The method of claim 14, wherein:
one of the N fragments has a transmission duration of the UWB radio of less than 100 microseconds; or
an NB poll packet has a transmission duration of the NB radio of less than 1000 microseconds.

20. The method of claim 19, further comprising configuring the NB radio to:
receive a NB response packet from the second wireless device after the transmission of the NB poll packet; or
receive a data packet from the second wireless device after the transmission of the data packet from the NB radio.
